(19) United States
(12) Patent Application Publication
(10) Pub. No.: US 2016/0373253 A1
(43) Pub. Date: Dec. 22, 2016

(54) COMMUNICATION DEVICE, COMMUNICATION SYSTEM, COMMUNICATION METHOD, AND COMPUTER PROGRAM PRODUCT

(71) Applicant: Kabushiki Kaisha Toshiba, Minato-ku (JP)

(72) Inventors: Takuya KAWAMURA, Kawasaki (JP); Yoshimichi TANIZAWA, Yokohama (JP); Yoshihiro OBA, Kawasaki (JP)

(73) Assignee: Kabushiki Kaisha Toshiba, Minato-ku (JP)

(21) Appl. No.: 15/044,541

(22) Filed: Feb. 16, 2016

(30) Foreign Application Priority Data
Jun. 18, 2015 (JP) 2015-123024

(51) Int. Cl. H04L 9/08; H04L 29/06

(52) U.S. Cl. CPC H04L 9/0858; H04L 63/0428

(57) ABSTRACT

A first determining unit determines a period of time during which there is possibility of wiretapping of data present in a data communication channel connected to another communication device. A second determining unit determines, with a length of the period of time as unit of time, size of a cryptographic key used for encrypting data to be transmitted to the other communication device via the data communication channel during each unit of time. A first obtaining unit obtains a first cryptographic key having the size, from a first storing unit storing therein cryptographic keys shared with the other communication device. A recognizing unit recognizes possibility of wiretapping with respect to the data communication channel. Until the possibility of the wiretapping is recognized, a encrypting unit repeatedly encrypts data to be transmitted to the other communication device during each unit of time using the first cryptographic key.

### CROSS-REFERENCE TO RELATED APPLICATIONS

This application is based upon and claims the benefit of priority from Japanese Patent Application No. 2015-123024, filed on Jun. 18, 2015; the entire contents of which are incorporated herein by reference.

### FIELD

Embodiments described herein relate generally to a communication device, a communication system, a communication method, and a computer program product.

### BACKGROUND

A quantum key distribution system is configured with a transmitter, a receiver, and an optical fiber link that connects the transmitter and the receiver. The transmitter transmits a string of single photons to the receiver via the optical fiber link (a quantum communication channel). After that, the transmitter and the receiver exchange control information with each other, and share cryptographic keys. This technology is implemented using the technology generally referred to as quantum key distribution (QKD). The cryptographic keys shared by the transmitter and the receiver are used and consumed in performing cryptographic data communication between the transmitter and the receiver or between an application connected to the transmitter and an application connected to the receiver.

In the quantum key distribution, it is important to see to it that transmission and reception of photon strings using the optical fiber link is done without any errors. However, due to the changes occurring in the optical fiber length because of the changes in the ambient temperature or due to the variation occurring in the communication characteristics such as the oscillation of the optical fiber; the state of the photons undergoes changes, and the suitable reception timing or the suitable reception light intensity undergoes variation. Such a phenomenon appears in the form of the error rate of the photon strings (i.e., the quantum bit error rate (QBER)) (hereinafter, simply referred to as “error rate”). Moreover, in the quantum key distribution, the photons used for the purpose of sharing cryptographic keys possess quantum uncertainty which is one of the basic principles of quantum mechanics indicating that the photons undergo physical changes when tapped. Due to such a principle, if the photons including the information of a cryptographic key transmitted from a transmitter are tapped (wiretapped) in the quantum communication channel by a wiretapper, then the photons undergo physical changes and the error rate goes up due to the wiretapping too. Because of such variation in the error rate, the receiver that receives the photons becomes able to detect that the photons are likely to have been wiretapped by a wiretapper. Regarding the information based on a photon string that is transmitted from the transmitter to the receiver using quantum key distribution, with the aim of cancelling out the bits in which an error has occurred due to wiretapping, a key distillation operation is performed that is accompanied by the exchange of control information as described above. The key distillation operation ensures that safe cryptographic keys are shared. However, since the number of cancelled-out bits increases in proportion to the greater error rate, the eventually-obtained cryptographic key becomes smaller in size. Herein, the amount of generation per unit of time of the shared cryptographic keys is called a secure key rate and serves as the indicator of the operation speed performance of the quantum key distribution system. That is, being able to use a number of cryptographic keys enables achieving high-speed and safe cryptographic data communication. Hence, it can be said that, higher the secure key rate, the higher is the level of sophistication of the quantum key distribution system.

The cryptographic keys shared between a transmitter and a receiver are consumed for the purpose of data encryption and data decryption during cryptographic data communication. Herein, a cryptographic communication method that is generally called the one-time pad (OTP) method is used. In the cryptographic communication using a cryptographic key according to the one-time pad method, it is ensured according to the information theory that no wiretapper having whatever knowledge can decipher the cryptographic communication. However, in the one-time pad method, since a different cryptographic key is used at the time of transmitting each piece of data, it becomes necessary to have a large number of cryptographic keys.

As far as achieving high-speed and large-capacity data communication, the present situation is that the secure key rate in the QKD is slow. In optical fiber transmission, the speed of data communication is in the order of gigabytes per second. In contrast, for example, the present situation is that the secure key rate in the QKD is in the order or megabytes. Hence, in order to use the cryptographic keys, which are shared in advance, according to the one-time pad method for the entire data, either the speed of data communication needs to be reduced or a large number cryptographic keys need to be communicated and stored in advance. However, if the speed of data communication exceeds the secure key rate, then the stored cryptographic keys are increasingly consumed thereby leading to the exhaustion of the cryptographic keys.

### BRIEF DESCRIPTION OF THE DRAWINGS

FIG. 1 is a diagram illustrating an exemplary overall configuration of a communication system;

FIG. 2 is a diagram illustrating an exemplary hardware configuration of a node;

FIG. 3 is a diagram illustrating an exemplary functional block configuration of nodes according to a first embodiment;

FIG. 4 is a sequence diagram for explaining an example of a cryptographic key generation operation performed in a node;

FIG. 5 is a diagram illustrating an example of changes occurring in the error rate from the start of wiretapping till the detection of wiretapping;

FIG. 6 is a diagram for explaining a wiretapping period implied in the first embodiment;

FIG. 7 is a diagram for explaining the operations performed to stop the repetitive usage of a cryptographic key due to the detection of wiretapping;

FIG. 8 is a flowchart for explaining an exemplary operation for calculating the size of cryptographic keys by referring to the wiretapping period and the data generation rate;

FIG. 9 is a flowchart for explaining the operation for obtaining a cryptographic key and the operation for performing cryptographic data communication during the wiretapping period;

FIG. 10 is a diagram for explaining an exemplary method of using a cryptographic key during the wiretapping period;

FIG. 11 is a diagram for explaining an operation for switching to the cryptographic key usage according to the one-time pad method after the termination of the repetitive usage of a cryptographic key;

FIG. 12 is a diagram for explaining an operation for resuming the repetitive use of another cryptographic key after the termination of the repetitive usage of a particular cryptographic key;

FIG. 13 is a diagram for explaining an operation for switching to the one-time pad method and then resuming the repetitive use after the termination of the repetitive usage of a particular cryptographic key;

FIG. 14 is a diagram illustrating an exemplary functional block configuration of nodes according to a first modification example of the first embodiment;

FIG. 15 is a diagram for explaining an operation for repetitive usage of two types of cryptographic keys;

FIG. 16 is a diagram illustrating an exemplary arrangement in a communication system according to a second embodiment;

FIG. 17 is a diagram illustrating an exemplary functional block configuration of nodes according to the second embodiment;

FIG. 18 is a diagram for explaining a wiretapping period implied in the second embodiment;

FIG. 19 is a diagram illustrating an example in which the communication system according to the second embodiment includes a plurality of imaging devices;

FIG. 20 is a diagram illustrating an example in which, in the communication system according to the second embodiment, a quantum communication channel and a classical communication channel are configured in the same optical fiber;

FIG. 21 is a diagram illustrating an exemplary functional block configuration of nodes according to a first modification example of the second embodiment; and

FIG. 22 is a diagram illustrating an exemplary functional block configuration of nodes according to a second modification example of the second embodiment.

### DETAILED DESCRIPTION

According to an embodiment, a communication device includes a first determining unit, a second determining unit, a first obtaining unit, a recognizing unit, and an encrypting unit. The first determining unit determines a period of time during which there is a possibility of wiretapping of data present in a data communication channel which establishes connection to another communication device. The second determining unit determines, with a length of the period of time as unit of time, size of a cryptographic key which is used for encrypting data to be transmitted to the other communication device via the data communication channel during each unit of time. The first obtaining unit obtains a first cryptographic key, which has the size, from a first storing unit which stores therein cryptographic keys that have been shared with the other communication device. The recognizing unit recognizes a possibility of wiretapping with respect to the data communication channel. Until the possibility of the wiretapping is recognized by the recognizing unit, the encrypting unit repeatedly encrypts data, which is to be transmitted to the other communication device, during each unit of time using the first cryptographic key obtained by the first obtaining unit.

Exemplary embodiments are described below in detail with reference to the accompanying drawings. Herein, the drawings are only schematic in nature, and the specific configuration should be determined by taking into account the explanation given below.

### First Embodiment

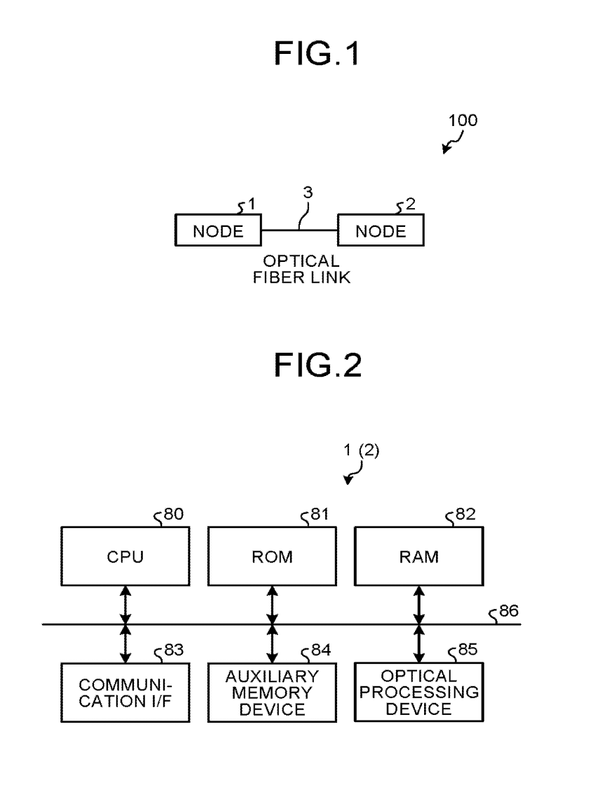

FIG. 1 is a diagram illustrating an exemplary overall configuration of a communication system. Thus, explained with reference to FIG. 1 is a configuration of a communication system 100.

As illustrated in FIG. 1, the communication system 100 includes a node 1 (a communication device) functioning as a transmitter, a node 2 (a communication device) functioning as a receiver, and an optical fiber link 3 (a physical medium).

The node 1 is a transmitter that transmits, to the node 2 via the optical fiber link 3, a photon string that is made of single photons which are generated by the laser and which serve as the basis for generating cryptographic keys. The node 1 performs a key distillation operation (described later) (i.e., a sifting operation, an error correction operation, and a privacy amplification operation) based on the photon string that is transmitted, so as to generate a cryptographic key. Moreover, during the key distillation operation, the node 1 exchanges control information (not the single photons but general-purpose digital data) with the node 2. Herein, the control information can be transferred between the nodes 1 and 2 either via the optical fiber link 3 or using another communication channel (such as the commonly-used Internet line). The communication channel meant for digital data and used in exchanging control information is sometimes called a classical communication channel.

The node 2 is a receiver that receives, from the node 1 via the optical fiber link 3, the photon string made of single photons that serve as the basis for generating cryptographic keys. The node 2 performs a key distillation operation (described later) (i.e., a sifting operation, an error correction operation, and a privacy amplification operation) based on the photon string that is received, so as to generate a cryptographic key that is identical to the cryptographic key generated by the node 1. Moreover, during the key distillation operation, the node 2 exchanges control information with the node 1.

The optical fiber link 3 is an optical fiber in which a photon communication channel is formed for the purpose of transmission and reception of photons and an optical data communication channel is formed for the purpose of optical data communication by implementing the wavelength division multiplex (WDM) technology in which light of different wavelengths is used. Herein, the technology that enables transmission and reception of photons for the purpose of quantum key distribution and enables optical data communication at the same time using the single optical fiber is termed as a “coexistence technology”. Thus, in the coexistence technology, a photon communication channel and an optical data communication channel are formed in the single optical fiber. As a result, it becomes possible to reduce the cost of laying a new optical fiber required to implement the communication system 100 representing a quantum key distribution system. Moreover, generally, the light used in the optical data communication channel has a strong optical intensity, while the light used in the photon communication channel has a weak optical intensity. For that reason, the light used in the optical data communication channel causes a noise for the photons in the photon communication channel. Because of such noise, the error rate in the photon communication channel goes on increasing, thereby making the operations of the quantum key distribution system unstable. In the coexistence technology, as a result of implementing the WDM technology, in which light of different wavelengths is used, along with a frequency filtering technology for the purpose of eliminating mutual interference in the light; it becomes possible to reduce the ratio by which the light in the optical data communication channel causes a noise in the photon communication channel, thereby enabling implementation of both channels at the same time.

The single photons output by the node 1 are transmitted to the node 2 via the photon communication channel serving as the quantum communication channel. On the other hand, communication data such as the control information is communicated between the nodes 1 and 2 via the optical data communication channel serving as the classical communication channel.

In the communication system 100 including the nodes 1 and 2, in case a wiretapper attempts to tap communication data from the optical data communication channel of the optical fiber link 3; the photons present in the optical communication channel, which is formed in the same optical fiber link 3, undergo physical changes. That leads to an increase in the error rate of the photon string, thereby enabling recognition of the possibility that the communication data in the optical data communication channel is being wiretapped.

Meanwhile, with reference to FIG. 1, although the optical fiber link 3 is configured with a single optical fiber link, it is alternatively possible to configure the optical fiber link 3 with a plurality of optical fiber links. However, it is assumed that, of the plurality of optical fiber links, at least a single optical fiber link has the photon communication channel and the photon data communication channel implemented therein at the same time. Besides, other than the photon communication channel and the optical data communication channel, for example, it is also possible to have a clock channel implemented separately for the purpose of exchanging clock signals required in achieving timing synchronization between the nodes 1 and 2.

Meanwhile, in the communication system 100, during the key distillation operation that needs to be performed for the purpose of sharing cryptographic keys between the nodes 1 and 2, the necessary control information either can be exchanged using the optical data communication channel as described above or can be exchanged using a dedicated channel implemented in the same optical fiber link 3 in which the photon communication channel and the optical data communication channel are implemented.

The data communicated using the optical data communication channel can be any type of data. As described earlier, the control information required in the key distillation operation can be exchanged as data or some other general-purpose data can be exchanged using the optical data communication channel. For example, consider a case in which the communication system 100 is built and implemented as part of an optical data communication infrastructure. It is possible to think of a possibility in which the node 1 or the node 2 is equipped not only with the function of sharing cryptographic keys but also with the function of an optical transceiver so as to enable an external device to communicate data via the optical fiber link 3. In that case, the data communicated by the node 1 or the node 2 using the optical data communication channel can be assumed to be a variety of data not limited to the communication system 100 representing a quantum key distribution system.

FIG. 2 is a diagram illustrating an exemplary hardware configuration of a node. Thus, explained with reference to FIG. 2 is a hardware configuration of a node. The following explanation is given for the node 1 as an example.

As illustrated in FIG. 2, the node 1 includes a central processing unit (CPU) 80, a read only memory (ROM) 81, a random access memory (RAM) 82, a communication interface (I/F) 83, an auxiliary memory device 84, and an optical processing device 85.

The CPU 80 is a processor that controls the operations of the entire node 1. The ROM 81 is a nonvolatile memory device used in storing computer programs executed by the CPU 80 to control various functions. The RAM 82 is a volatile memory device that functions as the work memory of the CPU 80.

The communication I/F 83 is an interface for communicating data with an external device via a network such as a local area network (LAN) or via a wireless network.

The auxiliary memory device 84 is a nonvolatile memory device used to store various computer programs executed by the CPU 80 and to store cryptographic keys generated as a result of performing a cryptographic key generation operation. The auxiliary memory device 84 is a memory device such as a hard disk drive (HDD), a solid state drive (SSD), a flash memory, or an optical disk in which information can be stored in an electrical, magnetic, or optical manner.

The optical processing device 85 is an optical device that transmits and receives photon strings via the photon communication channel (the quantum communication channel) of the optical fiber link 3. For example, the optical processing device 85 of the node 1 transmits, to the optical processing device 85 of the node 2 via the photon communication channel, a photon string that is made of single photons, which are generated to be in a polarization state or a phase state based on base information generated using a randomly-selected base, based on a bit string (a photon bit string) that represents bit information generated using random numbers. In the photon string generated by the optical processing device 85 of the node 1, each photon holds 1-bit information of either “0” or “1”. The optical processing device 85 of the node 2 receives the photon string from the optical processing device 85 of the node 1 via the photon communication channel, and obtains a photon bit string representing the bit information by reading the received photon string based on base information generated using a randomly-selected base. Moreover, via the optical data communication channel of the optical fiber link 3, the optical processing device 85 converts data into optical signals and sends the optical signals, or converts the received optical signals into data.

Meanwhile, the CPU 80, the ROM 81, the RAM 82, the communication I/F 83, the auxiliary memory device 84, and the optical processing device 85 are connected to each other in a communicable manner by a bus 86 such as an address bus and a data bus.

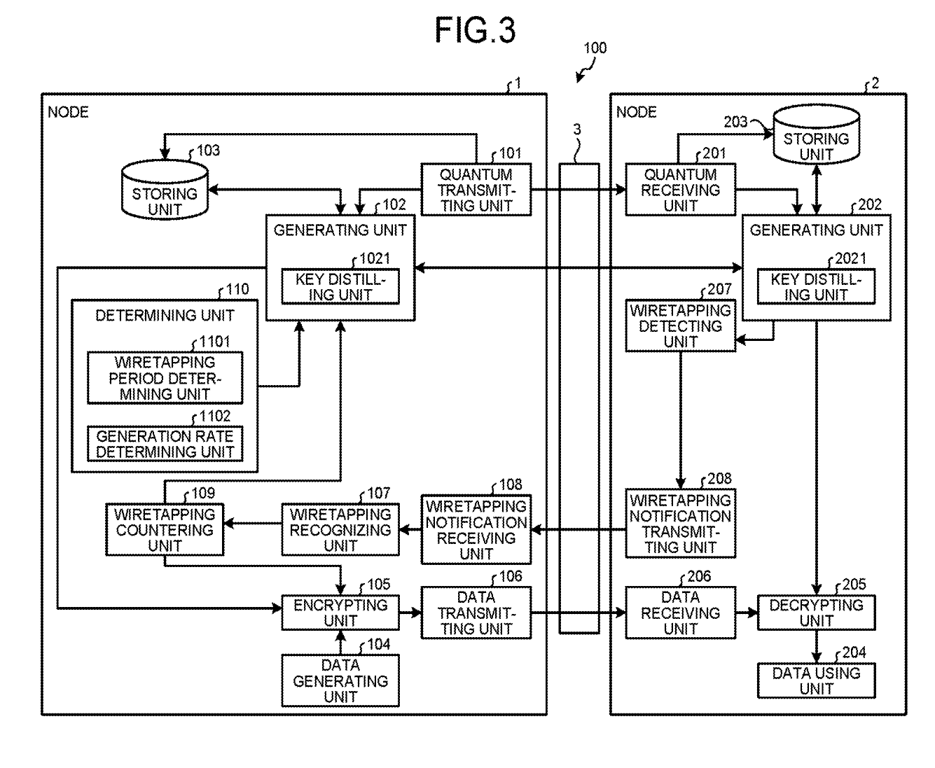

FIG. 3 is a diagram illustrating an exemplary functional block configuration of the nodes according to the first embodiment. Thus, explained with reference to FIG. 3 is a functional block configuration of the nodes 1 and 2.

As illustrated in FIG. 3, the node 1 includes a quantum transmitting unit 101 (a sharing unit), a generating unit 102 (a first obtaining unit), a storing unit 103 (a first storing unit), a data generating unit 104, an encrypting unit 105 (an encrypting unit), a data transmitting unit 106, a wiretapping recognizing unit 107 (a recognizing unit), a wiretapping notification receiving unit 108, a wiretapping countering unit 109, and a determining unit 110 (a second determining unit).

The quantum transmitting unit 101 is a functional unit that transmits, to a quantum receiving unit 201 of the node 2 via the photon communication channel, a photon string that is made of single photons, which are generated to be in a polarization state or a phase state based on base information generated using a randomly-selected base, based on a bit string (a photon bit string) that represents bit information generated using random numbers. The quantum transmitting unit 101 temporarily stores the generated photon bit string in the storing unit 103. The quantum transmitting unit 101 is implemented by the optical processing device 85 illustrated in FIG. 2.

The generating unit 102 is a functional unit that generates a cryptographic key, which is to be used in encrypting the data transmitted from the data transmitting unit 106, by obtaining a cryptographic key having the length (a size L′) that is determined by the determining unit 110 in the manner described later. At that time, the cryptographic keys stored in the storing unit 103 are consumed by an amount equivalent to the size obtained by the generating unit 102. Moreover, the generating unit 102 sends information about the size L′, which represents the length of cryptographic keys as determined by the determining unit 110, to a generating unit 202 via the optical data communication channel. Meanwhile, the generating unit 102 includes a key distilling unit 1021 (a key distilling unit).

The key distilling unit 1021 is a functional unit that communicates control information with a key distilling unit 2021 (described later) of the node 2 via the optical data communication channel, and performs a key distillation operation for generating a cryptographic key from the photon bit string. The detailed explanation of the key distillation operation is given later.

The storing unit 103 is a functional unit that stores therein the following: the photon bit string generated by the quantum transmitting unit 101; the intermediate data generated during the key distillation operation performed by the key distilling unit 1021; and the cryptographic key that is eventually generated. The storing unit 103 is implemented by the auxiliary memory device 84 illustrated in FIG. 2. In FIG. 3, although the storing unit 103 is illustrated to be included in the node 1, that is not the only possible case. Alternatively, the storing unit 103 can be implemented by a memory device present on the outside of the node 1.

The data generating unit 104 is an application that runs in the node 1 and that handles various types of data, and is a functional unit that sends data, which is to be transmitted to the node 2 (hereinafter, sometimes termed as “application data”), to the encrypting unit 105.

The encrypting unit 105 is a functional unit that obtains the cryptographic key from the generating unit 102 upon receiving the application data from the data generating unit 104 and that encrypts the application data using the cryptographic key. Then, the encrypting unit 105 sends the encrypted application data (hereinafter, sometimes termed as “cryptographic data”) to the data transmitting unit 106.

The data transmitting unit 106 is a functional unit that converts the cryptographic data, which is received from the encrypting unit 105, into optical signals and that transmits the optical signals of the cryptographic data to a data receiving unit 206 of the node 2 via the optical data communication channel of the optical fiber link 3. The data transmitting unit 106 is implemented by the optical processing device 85 illustrated in FIG. 2.

The wiretapping recognizing unit 107 is, as described later, a functional unit that receives a wiretapping detection signal from the wiretapping notification receiving unit 108, so as to recognize the risk of wiretapping in the optical data communication channel of the optical fiber link 3. Upon recognizing the risk of wiretapping, the wiretapping recognizing unit 107 instructs the wiretapping countering unit 109 to perform a wiretapping countering operation.

The wiretapping notification receiving unit 108 is, as described later, a functional unit that receives a wiretapping detection notification signal from a wiretapping notification transmitting unit 208 of the node 2 via the classical communication channel (such as the optical data communication channel) and that sends a wiretapping detection signal to the wiretapping recognizing unit 107. In the case of receiving a wiretapping detection notification signal via the optical data communication channel, the wiretapping notification receiving unit 108 is implemented by the optical processing device 85 illustrated in FIG. 2. On the other hand, in the case of receiving a wiretapping detection notification signal via a classical communication channel other than the optical data communication channel, the wiretapping notification receiving unit 108 is implemented by the communication I/F 83 illustrated in FIG. 2. Meanwhile, when a wiretapping detection notification signal received from the wiretapping notification transmitting unit 208 is in an encrypted form, the wiretapping notification receiving unit 108 can obtain a cryptographic key equivalent to the size of the wiretapping detection notification signal from the generating unit 102 and can decrypt the wiretapping detection notification signal using the cryptographic key. The same is true regarding a wiretapping end notification signal (described later).

The wiretapping countering unit 109 is a functional unit that receives an instruction to perform a wiretapping countering operation from the wiretapping recognizing unit 107 and that performs a wiretapping countering operation. The specific details of the wiretapping countering operation are given later.

The determining unit 110 is a functional unit that determines the size L′ greater than the size L of the application data sent by the data generating unit 104 to the encrypting unit 105 during a wiretapping period T that includes the time slot within which the data that is at risk of being actually wiretapped is transmitted using the optical data communication channel. Regarding the method of determining the size L′, the explanation is given later. The determining unit 110 includes a wiretapping period determining unit 1101 (a first determining unit) and a generation rate determining unit 1102.

The wiretapping period determining unit 1101 is a functional unit that determines the wiretapping period T that includes the time slot within which the data is at risk of actually being wiretapped is transmitted using the optical data communication channel. Regarding the method of determining the wiretapping period T, the explanation is given later.

The generation rate determining unit 1102 is a functional unit that determines a generation rate R′ greater than the maximum value of a generation rate R at which the data generating unit 104 generates application data per unit of time and sends it to the encrypting unit 105. Regarding the method of generating the generation rate R′, the explanation is given later.

Meanwhile, the generating unit 102, the data generating unit 104, the encrypting unit 105, the wiretapping recognizing unit 107, the wiretapping countering unit 109, and the determining unit 110 are implemented when the CPU 80 illustrated in FIG. 2 reads computer programs from the auxiliary memory device 84 into the RAM 82 and executes them. However, all of the generating unit 102, the data generating unit 104, the encrypting unit 105, the wiretapping recognizing unit 107, the wiretapping countering unit 109, and the determining unit 110 need not be implemented by the execution of computer programs. Alternatively, at least one of the generating unit 102, the data generating unit 104, the encrypting unit 105, the wiretapping recognizing unit 107, the wiretapping countering unit 109, and the determining unit 110 can be implemented using hardware circuitry such as an application specific integrated circuit (ASIC), a field-programmable gate array (FPGA), or some other integrated circuit.

Meanwhile, the quantum transmitting unit 101, the generating unit 102, the storing unit 103, the data generating unit 104, the encrypting unit 105, the data transmitting unit 106, the wiretapping recognizing unit 107, the wiretapping notification receiving unit 108, the wiretapping countering unit 109, and the determining unit 110 illustrated in FIG. 3 are meant to illustrate the functions thereof in a conceptual manner. That is, the configuration is not limited to the functional block configuration illustrated in FIG. 3. Alternatively, for example, a plurality of independent functional units illustrated in FIG. 3 can be combined as a single functional unit. On the other hand, the function of a single functional unit illustrated in FIG. 3 can be divided into a plurality of functions and can be implemented using a plurality of functional units.

As illustrated in FIG. 3, the node 2 includes the quantum receiving unit 201, the generating unit 202 (a second obtaining unit), a storing unit 203 (a second storing unit), a data using unit 204, a decrypting unit 205 (a decrypting unit), a data receiving unit 206 (a receiving unit), a wiretapping detecting unit 207, and the wiretapping notification transmitting unit 208.

The quantum receiving unit 201 is a functional unit that receives, from the quantum transmitting unit 101 of the node 1 via the photon communication channel, a photon string and that obtains a photon bit string representing the bit information by reading the received photon string based on base information generated using a randomly-selected base. Then, the quantum receiving unit 201 temporarily stores the generated photon bit string in the storing unit 203. The quantum receiving unit 201 is implemented by the optical processing device 85 illustrated in FIG. 2.

The generating unit 202 is a functional unit that receives information about the length (the size L′) of the cryptographic key via the optical data communication channel from the generating unit 102 and that generates a cryptographic key, which is to be used in decrypting the data received by the data receiving unit 206, by obtaining a cryptographic key having the size L′ from the storing unit 203. At that time, the cryptographic keys stored in the storing unit 203 are consumed by an amount equivalent to the size obtained by the generating unit 202. Herein, the generating unit 202 includes a key distilling unit 2021.

The key distilling unit 2021 is a functional unit that communicates control information with the key distilling unit 1021 of the node 1 via the optical data communication channel, so as to perform a key distillation operation for generating a cryptographic key from the photon bit string.

The storing unit 203 is a functional unit that stores therein the following: the photon bit string generated by the quantum receiving unit 201; intermediate data generated during the key distillation operation performed by the key distilling unit 2021; and the cryptographic key that is eventually generated. The storing unit 203 is implemented by the auxiliary memory device 84 illustrated in FIG. 2. In FIG. 3, although the storing unit 203 is illustrated to be included in the node 2, that is not the only possible case. Alternatively, the storing unit 203 can be implemented by a memory device present on the outside of the node 2.

The data using unit 204 is an application running in the node 2 for handling a variety of data and is a functional unit that receives application data that was received by the decrypting unit 205 from the node 1 and that makes use of the application data.

The decrypting unit 205 is, as described later, a functional unit that receives cryptographic data from the data receiving unit 206, that obtains the cryptographic key from the generating unit 202, and that decrypts the cryptographic data using the cryptographic key. Moreover, the decrypting unit 205 sends application data, which is obtained by decrypting the cryptographic data, to the data using unit 204.

The data receiving unit 206 is a functional unit that converts optical signals, which are received from the data transmitting unit 106 via the optical data communication channel, into cryptographic data and sends it to the decrypting unit 205. The data receiving unit 206 is implemented by the optical processing device 85 illustrated in FIG. 2.

The wiretapping detecting unit 207 is a functional unit that obtains the error rate of the photon communication channel (the quantum communication channel) as calculated during the key distillation operation performed by the key distilling unit 2021 of the generating unit 202, that performs a wiretapping determination operation (described later) based on the error rate, and that detects the possibility of wiretapping by a wiretapper. For example, when the obtained error rate is greater than a predetermined threshold value, the wiretapping detecting unit 207 detects that there is a possibility of wiretapping. When the possibility of wiretapping is detected, the wiretapping detecting unit 207 sends a wiretapping detection signal to the wiretapping notification transmitting unit 208. Thus, herein, the data (such as application data) communicated using the optical data communication channel is the target for wiretapping intended by the wiretapper; and the possibility of wiretapping with respect to the data in the optical data communication channel is detected based on the error rate of the photon string in the optical photon communication channel that is implemented in the same optical fiber link 3 as a result of implementing the coexistence technology.

The wiretapping notification transmitting unit 208 is a functional unit that receives the wiretapping detection signal from the wiretapping detecting unit 207 and that transmits a wiretapping detection notification signal to the wiretapping notification receiving unit 108 of the node 1 via the classical communication channel (such as the optical data communication channel). That is, by transmitting a wiretapping detection notification signal to the node 1, the wiretapping notification transmitting unit 208 notifies the node 1 about the detection of a possibility of wiretapping of the data in the optical data communication channel. In the case of transmitting the wiretapping detection notification signal via the optical data communication channel, the wiretapping notification transmitting unit 208 is implemented by the optical processing device 85 illustrated in FIG. 2. On the other hand, in the case of transmitting the wiretapping detection notification signal via a classical communication channel other than the optical data communication channel, the wiretapping notification transmitting unit 208 is implemented by the communication I/F 83 illustrated in FIG. 2. Meanwhile, at the time of transmitting a wiretapping detection notification signal, the wiretapping notification transmitting unit 208 can obtain a cryptographic key equivalent to the size of the wiretapping detection notification signal from the generating unit 202 and can encrypt the wiretapping detection notification signal using the cryptographic key, and then transmit the encrypted wiretapping detection notification signal to the wiretapping notification receiving unit 108. The same is true regarding a wiretapping end notification signal (described later).

Meanwhile, the generating unit 202, the data using unit 204, the decrypting unit 205, and the wiretapping detecting unit 207 are implemented when the CPU 80 illustrated in FIG. 2 reads computer programs from the auxiliary memory device 84 into the RAM 82 and executes them. However, all of the generating unit 202, the data using unit 204, the decrypting unit 205, and the wiretapping detecting unit 207 need not be implemented by the execution of computer programs. Alternatively, at least one of the generating unit 202, the data using unit 204, the decrypting unit 205, and the wiretapping detecting unit 207 can be implemented using hardware circuitry such as an application specific integrated circuit (ASIC), a field-programmable gate array (FPGA), or some other integrated circuit.

Meanwhile, the quantum receiving unit 201, the generating unit 202, the storing unit 203, the data using unit 204, the decrypting unit 205, the data receiving unit 206, the wiretapping detecting unit 207, and the wiretapping notification transmitting unit 208 illustrated in FIG. 3 are meant to illustrate the functions thereof in a conceptual manner. That is, the configuration is not limited to the functional block configuration illustrated in FIG. 3. Alternatively, for example, a plurality of independent functional units illustrated in FIG. 3 can be combined as a single functional unit. On the other hand, the function of a single functional unit illustrated in FIG. 3 can be divided into a plurality of functions and can be implemented using a plurality of functional units.

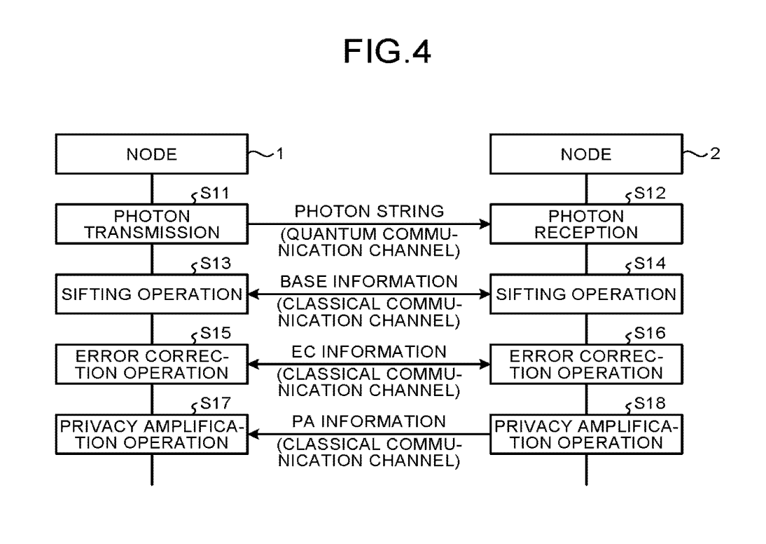

FIG. 4 is a sequence diagram for explaining an example of the cryptographic key generation operation performed in a node. Thus, explained with reference to FIG. 4 is explained a flow of the cryptographic key generation operation that includes a sifting operation and a key distillation operation.

Step S11

The quantum transmitting unit 101 transmits, to the quantum receiving unit 201 of the node 2 via the photon communication channel, a photon string that is made of single photons, which are generated to be in a polarization state or a phase state based on base information generated using a randomly-selected base, based on a photon bit string (a bit string) that represents bit information generated using random numbers. Then, the quantum transmitting unit 101 sends the base information and the photon bit string to the key distilling unit 1021 of the generating unit 102.

Step S12

The quantum receiving unit 201 receives, from the quantum transmitting unit 101 of the node 1 via the photon communication channel, a photon string and obtains a photon bit string (bit string) representing the bit information by reading the received photon string based on base information generated using a randomly-selected base. Then, the quantum receiving unit 201 sends the base information and the photon bit string to the key distilling unit 2021 of the generating unit 202.

Step S13

The key distilling unit 1021 receives the base information, which is generated by the quantum receiving unit 201 of the node 2, from the key distilling unit 2021 of the node 2 via the classical communication channel (such as the optical data communication channel); and performs a sifting operation that includes comparing the received base information with the base information generated by the quantum transmitting unit 101, extracting the bits corresponding to the matching portion from the photon bit string, and generating a shared bit string.

Step S14

The key distilling unit 2021 receives the base information, which is generated by the quantum transmitting unit 101 of the node 1, from the key distilling unit 1021 of the node 1 via the classical communication channel (such as the optical data communication channel); and performs a sifting operation that includes comparing the received base information with the base information generated by the quantum receiving unit 201, extracting the bits corresponding to the matching portion from the photon bit string, and generating a shared bit string.

Step S15

The key distilling unit 1021 performs an error correction operation that includes exchanging control information (error correction (EC) information) with the key distilling unit 2021 of the node 2 via the classical data communication channel (such as the optical data communication channel); correcting the bit errors in the shared bit string; and generating a post-correction bit string.

Step S16

The key distilling unit 2021 performs an error correction operation that includes exchanging control information (error correction (EC) information) with the key distilling unit 1021 of the node 1 via the classical data communication channel (such as the optical data communication channel); correcting the bit errors in the shared bit string; and generating a post-correction bit string. Moreover, when the error correction operation is performed with respect to the shared bit string thereby resulting in the generation of a post-correction bit string, the key distilling unit 2021 calculates an error rate that represents the percentage of error bits calculated during the error correction from the number of corrected errors in the shared bits between the nodes 1 and 2. Then, the key distilling unit 2021 sends the calculated error rate to the wiretapping detecting unit 207.

Step S17

The key distilling unit 1021 receives control information (privacy amplification (PA) information) from the key distilling unit 2021 of the node 2 via the classical communication channel (such as the optical data communication channel); and, based on the PA information, performs a key compression operation (a privacy amplification operation) with respect to the post-correction bit string with the aim of cancelling out, from the EC information communicated during the error correction operation, the volume of information that is likely to have been tapped by a wiretapper, and generates a cryptographic key. Then, the key distilling unit 1021 stores the generated cryptographic key in the storing unit 103.

Step S18

The key distilling unit 2021 generates control information (PA information) and transmits it to the key distilling unit 1021 of the node 1 via the classical communication channel (such as the optical data communication channel); and, based on the PA information, performs a key compression operation (a privacy amplification operation) with respect to the post-correction bit string with the aim of cancelling out, from the EC information communicated during the error correction operation, the volume of information that is likely to have been tapped by a wiretapper, and generates a cryptographic key. Then, the key distilling unit 2021 stores the generated cryptographic key in the storing unit 203.

As a result of performing the operations described above, identical cryptographic keys are generated in the nodes 1 and 2. By performing the operations described above in a repeated manner, different cryptographic keys are generated in a repeated manner. The cryptographic keys that are generated in a repeated manner are stored in the storing units 103 and 203, and are used in the data communication performed between the nodes 1 and 2 via the optical data communication channel or are used in the data communication performed between external applications, which are connected to the nodes 1 and 2, via an external network.

Meanwhile, as described earlier, communication of base information and communication of a variety of control information between the nodes 1 and 2 during the key distillation operation can be done using the optical data communication channel. However, since the communication includes special communication closed within the quantum key distribution system and includes fundamental communication directly linked to the key distillation operation, and since the key distillation operation requires complex calculations; it is alternatively possible to form a dedicated channel in the optical fiber link 3 for such communication. In that case, the dedicated channel serves as a special channel used internally by the nodes 1 and 2 of the quantum key distribution system. Hence, the light intensity of the dedicated channel can be designed freely. If the light intensity of the dedicated channel is set to be sufficiently weak, then the noise effect produced by the dedicated channel on the photon communication channel is nearly ignorable.

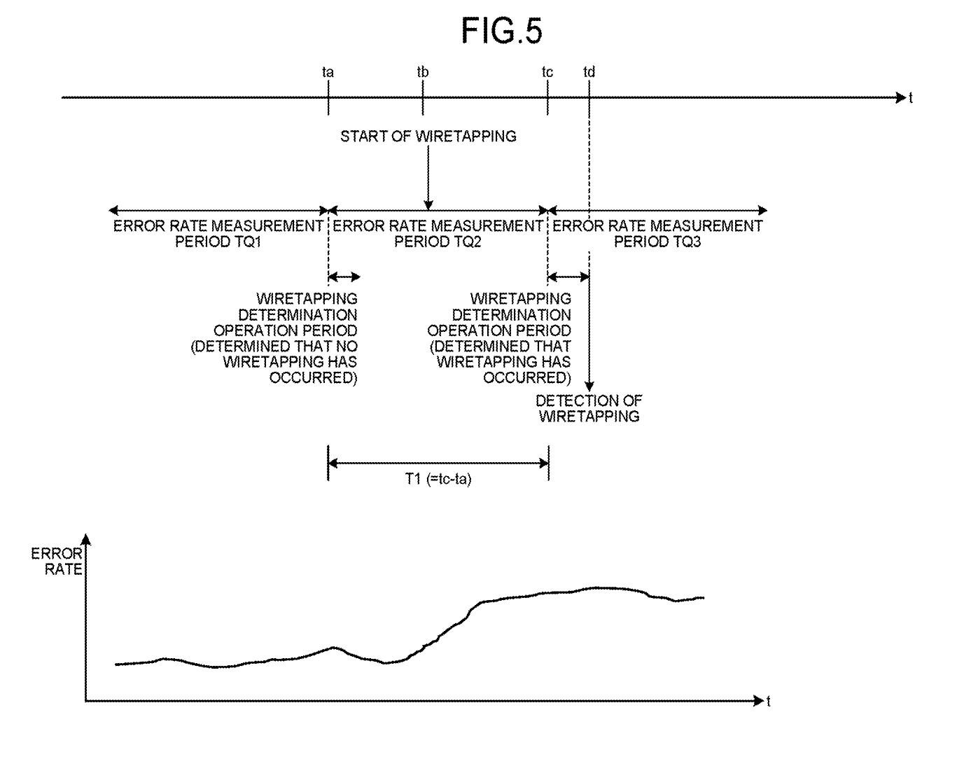

FIG. 5 is a diagram illustrating an example of changes occurring in the error rate from the start of wiretapping till the detection of wiretapping. Explained with reference to FIG. 5 is a wiretapping determination operation performed by the wiretapping detecting unit 207.

On the time axis illustrated in FIG. 5, the wiretapping detecting unit 207 performs measurement at predetermined time intervals regarding the error rate of the photon string in the quantum communication channel (the photon communication channel). In FIG. 5, three periods of time, namely, TQ1 to TQ3 represent error rate measurement periods in which the error rate is measured. Herein, on the time axis, a timing ta represents the timing at which the error rate measurement period TQ1 changes to the error rate measurement period TQ2; and a timing tc represents the timing at which the error rate measurement period TQ2 changes to the error rate measurement period TQ3. The error rate measurement period TQ2 is expressed as the period from the timing ta to the timing tc, and is termed as an error rate measurement period T1. However, since all error rate measurement periods are identical as described above, the error rate measurement periods TQ1 and TQ3 also represent the error rate measurement period T1.

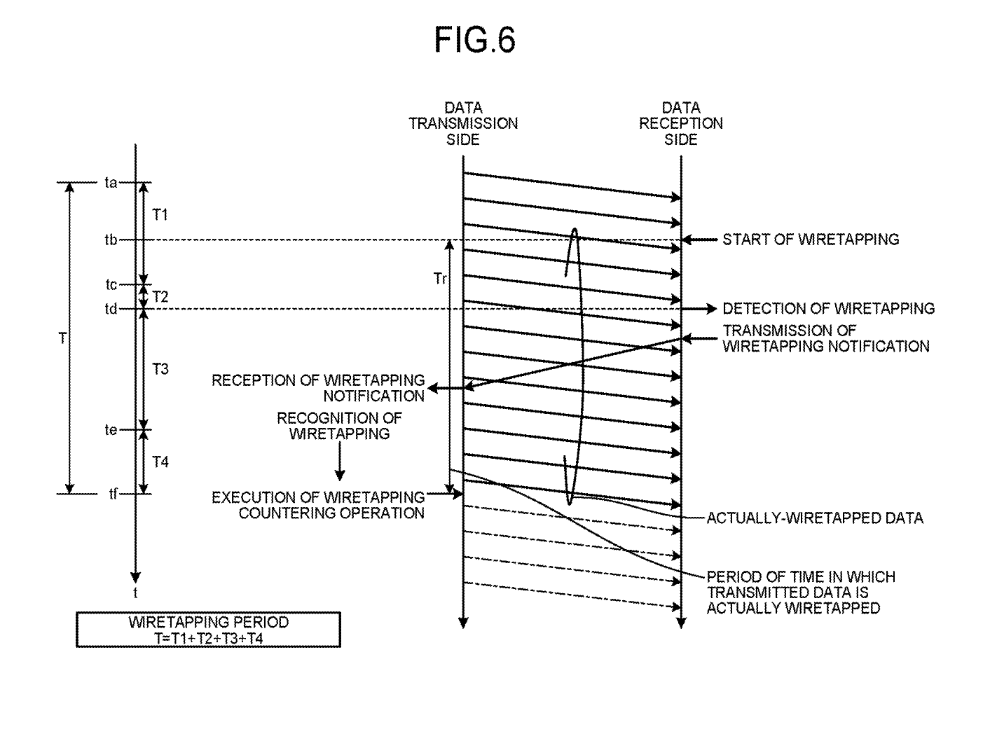

The wiretapping detecting unit 207 performs the wiretapping determination operation for a predetermined period of time (a wiretapping determination operation period T2 illustrated in FIG. 6 (described later)) after each error rate measurement period. For example, with reference to FIG. 5, after the elapse of the error rate measurement period TQ2, assume that the timing tc represents the timing at which the wiretapping determination operation is started and a timing td represents the timing at which the wiretapping determination operation ends. As the specific wiretapping determination operation, as described above, the wiretapping detecting unit 207 obtains the error rate of the photon communication channel as calculated by the key distilling unit 2021 during the key distillation operation. When the error rate exceeds a predetermined threshold value, the wiretapping detecting unit 207 determines that there is a possibility of wiretapping. That is, when the error rate is smaller than the predetermined threshold value, the wiretapping detecting unit 207 determines that there is no possibility of wiretapping. However, when the error rate exceeds the predetermined threshold value, the wiretapping detecting unit 207 determines that there is a possibility of wiretapping and detects the possibility of wiretapping.

Herein, it is assumed that wiretapping with respect to the optical data communication channel of the optical fiber link 3 is started by a wiretapper between the timings ta and tc, that is, started by a wiretapper at a timing tb of the error rate measurement period TQ2. After the timing tb at which the wiretapping is started, there is an increase in the error rate of the photon communication channel. During the wiretapping determination operation performed after the elapse of the error rate determination period TQ1, since wiretapping has not yet started, the wiretapping detecting unit 207 determines that there is no possibility of wiretapping because the error rate is smaller than a predetermined threshold value. On the other hand, when wiretapping is started at the timing tb, during the wiretapping determination operation after the elapse of the error rate measurement period TQ2, the error rate exceeds the predetermined threshold value due to the effect of wiretapping and the wiretapping detecting unit 207 determines that there is possibility of wiretapping. Thus, as a result of performing the wiretapping determination operation after the elapse of the error rate measurement period TQ2, the wiretapping detecting unit 207 detects the possibility that wiretapping was started at some timing during the error rate measurement period TQ2 after the timing ta.

Meanwhile, if the error rate measurement period T1 is shortened, then the time interval between the timing at which the error rate measurement period started (in the example illustrated in FIG. 5, the timing ta) and the timing at which wiretapping was started (in the example illustrated in FIG. 5, the timing tb) becomes smaller. However, if the error rate measurement period T1 is shortened too much, then it leads to vulnerability against the variation error of the error rate. Hence, it is desirable that the error rate measurement period T1 is secured to be equal to or greater than a predetermined period of time.

Alternatively, the wiretapping detecting unit 207 can determine the presence or absence of the possibility of wiretapping based on the wiretapping rate calculated by the key distilling unit 2021 at each instance of performing the key distillation operation. Still alternatively, the wiretapping detecting unit 207 can determine the presence or absence of the possibility of wiretapping based on the average value or the value of integral of the error rate during each instance of the error rate measurement period T1 or based on the moving average value of the error rate across the error rate measurement periods T1.

FIG. 6 is a diagram for explaining a wiretapping period implied in the first embodiment. Explained with reference to FIG. 6 is a wiretapping period T determined by the wiretapping period determining unit 1101 of the determining unit 110.

With reference to FIG. 6, the timing ta represents the start timing of the error rate measurement period T1 (in the example illustrated in FIG. 5, the error rate measurement period TQ2) (a first time period), and the timing tc represents the end timing of the error rate measurement period T1 as explained with reference to FIG. 5. Moreover, as described earlier, it is assumed that wiretapping with respect to the optical data communication channel of the optical fiber link 3 is started by a wiretapper at the timing tb between the timings ta and tc. Furthermore, the wiretapping detecting unit 207 starts the wiretapping determination operation at the timing tc after the elapse of the error rate measurement period T1 and ends the wiretapping determination operation at the timing td. Herein, the period of time between the timings tc and td, that is, the period of time taken by the wiretapping detecting unit 207 to perform the wiretapping determination operation represents the wiretapping determination operation period T2.

As illustrated in FIG. 6, the wiretapping is started at the timing tb. Hence, at the timing td at which the wiretapping determination operation ends, the wiretapping detecting unit 207 detects that there is a possibility of wiretapping. When the possibility of wiretapping is detected, the wiretapping detecting unit 207 sends a wiretapping detection signal to the wiretapping notification transmitting unit 208, which then transmits a wiretapping detection notification signal to the wiretapping notification receiving unit 108 via the classical communication channel (such as the optical data communication channel). Upon receiving the wiretapping detection notification signal from the wiretapping notification transmitting unit 208, the wiretapping notification receiving unit 108 sends a wiretapping detection signal to the wiretapping recognizing unit 107. As a result of receiving the wiretapping detection signal from the wiretapping notification receiving unit 108, the wiretapping recognizing unit 107 recognizes the possibility of wiretapping with respect to the optical data communication channel. As illustrated in FIG. 6, a timing te represents the timing at which the wiretapping recognizing unit 107 recognizes the possibility of wiretapping. Herein, the period of time between the timings td and te, that is, the period of time taken for notifying the possibility of wiretapping from the node 2 to the node 1 represents a wiretapping notification period T3 (a second time period).

Once the possibility of wiretapping is recognized as a result of receiving the wiretapping detection signal, the wiretapping recognizing unit 107 instructs the wiretapping countering unit 109 to perform a wiretapping countering operation. Upon receiving the instruction to perform a wiretapping countering operation from the wiretapping recognizing unit 107, the wiretapping countering unit 109 performs the wiretapping countering operation. As illustrated in FIG. 6, a timing tf represents the timing at which the wiretapping countering unit 109 performs the wiretapping countering operation. Herein, the period of time between the timings te and tf, that is, the period of time between the recognition of the possibility of wiretapping by the wiretapping recognizing unit 107 and the execution of the wiretapping countering operation by the wiretapping countering unit 109 represents a wiretapping countering period T4.

The wiretapping period determining unit 1101 of the determining unit 110 adds the error rate measurement period T1 set as a predetermined period of time, the wiretapping determination operation period T2 set as an estimate value, the wiretapping notification period T3 set as an estimate value, and the wiretapping countering period T4 set as an estimate value; and determines the wiretapping period T (=T1+T2+T3+T4). As illustrated in FIG. 6, of the wiretapping period T, the timing tb after the timing ta represents the timing of actual wiretapping. Hence, an actual wiretapping period Tr representing the period of time in which the data is actual wiretapped is included in the wiretapping period T (i.e., T>Tr is satisfied). Meanwhile, instead of determining the wiretapping period T, the wiretapping period determining unit 1101 can determine a wiretapping period T′ (=T+α) obtained by adding a margin value α to the wiretapping period T. The margin value α represents a value for absorbing the estimation error of the wiretapping determination operation period T2, the wiretapping notification period T3, and the wiretapping countering period T4 set as estimate values. For example, the wiretapping determination operation period T2 varies according to the volume of resources of the node 2. The wiretapping notification period T3 varies according to the state of the optical data communication channel of the optical fiber link 3. The wiretapping countering period T4 varies according to the resources of the node 1. Hence, the margin value α is set by taking into account such amount of variation. Meanwhile, the wiretapping periods T and T′ can be calculated in advance. In this way, the wiretapping period determining unit 1101 can determine either one of the wiretapping periods T and T′. In the following explanation, it is assumed that the wiretapping period T is determined.

Herein, the wiretapping period determining unit 1101 determines the wiretapping period T as the sum of the error rate measurement period T1, the wiretapping determination operation period T2, the wiretapping notification period T3, and the wiretapping countering period T4. However, alternatively, since the wiretapping determination operation period T2 and the wiretapping countering period T4 are sufficiently smaller periods of time as compared to the error rate measurement period T1 and the wiretapping notification period T3, the wiretapping period determining unit 1101 determines the wiretapping period T based on the error rate measurement period T1 and the wiretapping notification period T3.

Meanwhile, the wiretapping determination operation period T2, the wiretapping notification period T3, and the wiretapping countering period T4 are assumed to be estimate values. Alternatively, the wiretapping period T can be determined using actually-measured values (actual measurement values). Moreover, the error rate measurement period T1, the wiretapping determination operation period T2, the wiretapping notification period T3, and the wiretapping countering period T4 can be allowed to be input using an input unit (not illustrated). Furthermore, the wiretapping period T (or the wiretapping period T′) can be set in advance as a predetermined value in the wiretapping period determining unit 1101.

As illustrated in FIG. 6, although there is a possibility of wiretapping in the wiretapping period T after the timing ta, it is believed that no wiretapping has occurred in the period of time before the timing ta. However, as described later, after the timing ta, even if the data transmitted during the wiretapping period T is wiretapped, it is impossible for the wiretapper to decrypt the data because a cryptographic key having the same length as the data length is used according to the one-time pad method. Thus, after the timing tf, unless the cryptographic key that was used in the period between the timings ta and tf is reused, the data wiretapped in the period between the timings ta and tf cannot be decrypted.

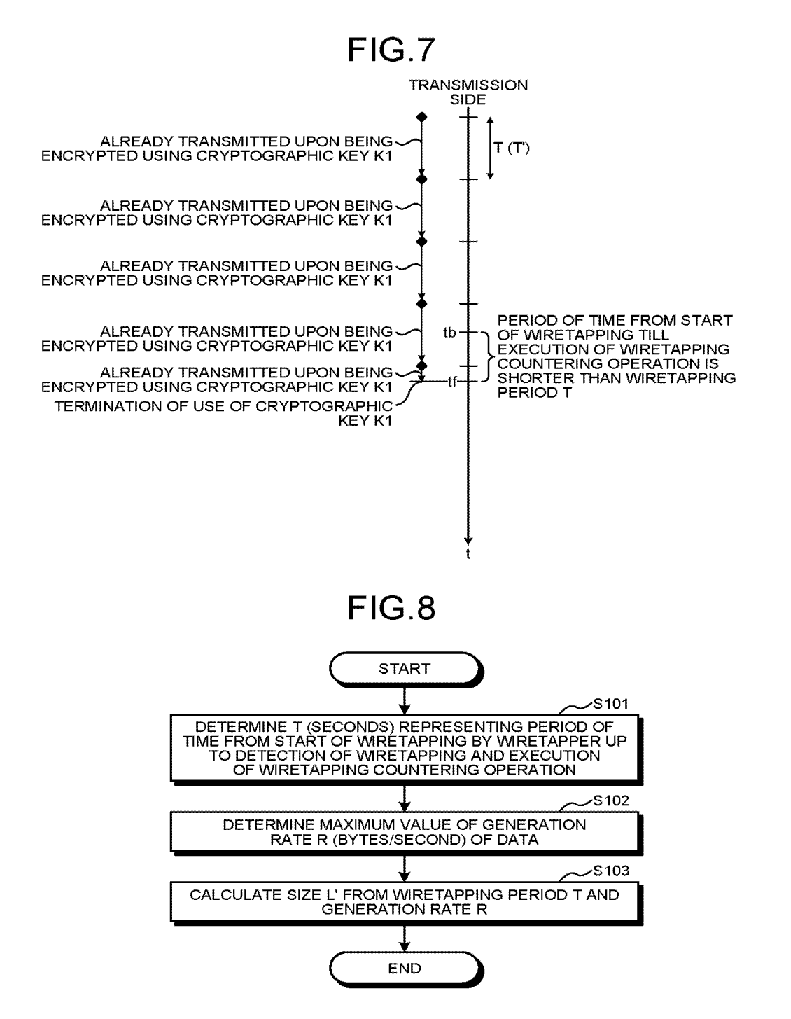

Moreover, if wiretapping has not occurred before the timing ta, even if the cryptographic key that was used in the wiretapping period T from the timing ta to the timing tf was used before the timing ta too, the wiretapper who started wiretapping after the timing ta does not obtain the data encrypted by the same cryptographic key before the timing ta. Thus, the cryptographic key used in the wiretapping period T from the timing ta to the timing tf is identical to a disposable cryptographic key used only once to the wiretapper. In connection with that, with reference to FIGS. 7 to 10, given below is the explanation of the operation for repetitive usage of a cryptographic key in the communication system 100 and the wiretapping countering operation in the case of detection of the possibility of wiretapping.

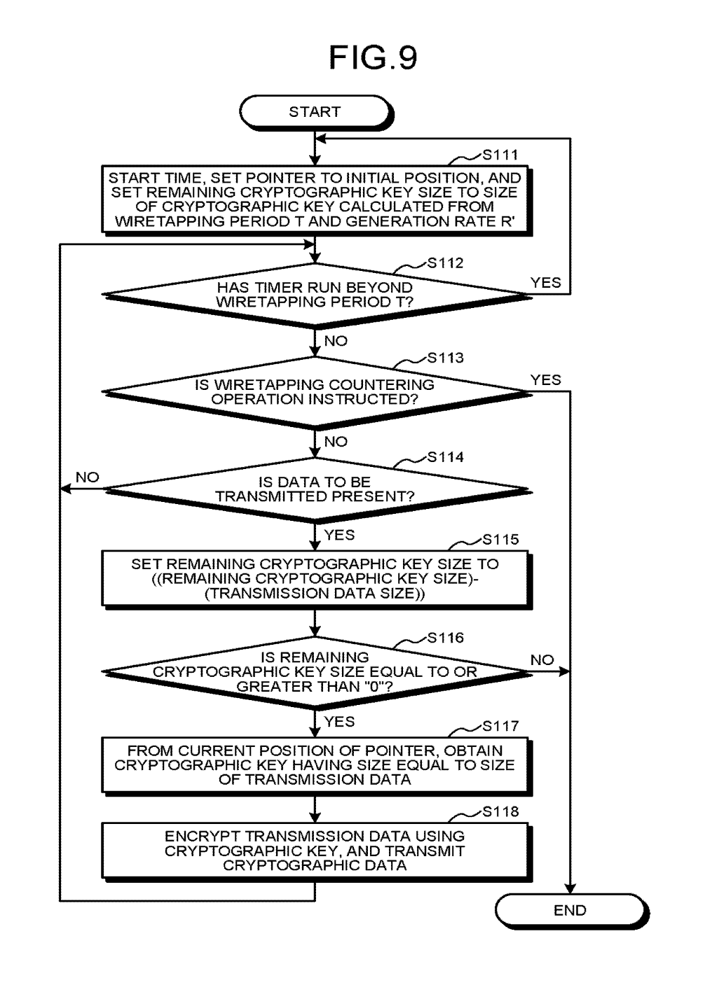

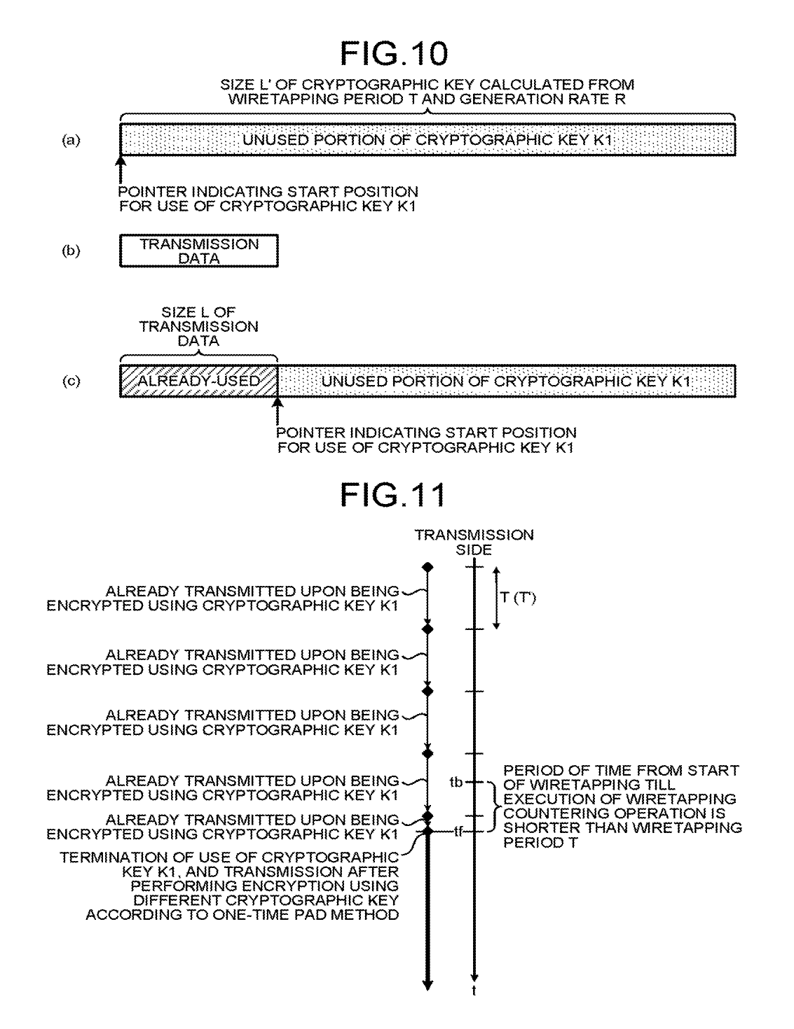

FIG. 7 is a diagram for explaining the operations performed to stop the repetitive usage of a cryptographic key due to the detection of wiretapping. FIG. 8 is a flowchart for explaining an exemplary operation for calculating the size of cryptographic keys by referring to the wiretapping period and the data generation rate. FIG. 9 is a flowchart for explaining the operation for obtaining a cryptographic key and the operation for performing cryptographic data communication during the wiretapping period. FIG. 10 is a diagram for explaining an exemplary method of using a cryptographic key during the wiretapping period. Thus, with reference to FIGS. 7 to 10, the explanation is given about the operation for repetitive usage of a cryptographic key and about the wiretapping countering operation in the case of detection of the possibility of wiretapping.

As illustrated in FIG. 7, in the communication system 100 according to the first embodiment, during each wiretapping period T determined by the wiretapping period determining unit 1101 of the determining unit 110, same cryptographic key K1 (a first cryptographic key) that is generated and shared between the nodes 1 and 2 is used in a repeated manner. That is, in the node 1, the encrypting unit 105 repeatedly uses the cryptographic key K1, which is obtained from the generating unit 102, during each wiretapping period T; encrypts the application data; and sends the cryptographic data to the node 2 via the data transmitting unit 106. In the node 2, the decrypting unit 205 repeatedly uses the cryptographic key K1 (the cryptographic key shared with the node 1), which is obtained from the generating unit 202, during each wiretapping period T and decrypts the received cryptographic data. Herein, using the cryptographic key K1 in a repeated manner during each wiretapping period K1 implies the following: treating the wiretapping period T, which is determined by the wiretapping period determining unit 1101, as the unit of time; encrypting the application data, which is sent during each unit of time, using the cryptographic key K1; and decrypting the application data, which is received during each unit of time, using the cryptographic key K1.

The encrypting unit 105 obtains, from the generating unit 102, a cryptographic key having the size L′ that is greater than the size L of the application data which is output during each wiretapping period T by the data generating unit 104 to the encrypting unit 105. As described earlier, the wiretapping period T is determined by the wiretapping period determining unit 1101, and the size L′ is determined by the determining unit 110. The determining unit 110 sends the information about the size L′ and about the wiretapping period T to the generating unit 102. Then, for example, via the optical data communication channel of the optical fiber link 3, the generating unit 102 sends the information about the size L′ and about the wiretapping period T to the generating unit 202. With that, the decrypting unit 205 can obtain the cryptographic key having the size L′ from the generating unit 202, and can repeatedly use the cryptographic key having the size L′ during each wiretapping period T.

Explained below with reference to FIG. 8 is the operation by which the determining unit 110 determines (calculates) the size L′.

Step S101

As described earlier, the wiretapping period determining unit 1101 of the determining unit 110 adds the error rate measurement period T1 set as a predetermined period of time, the wiretapping determination operation period T2 set as an estimate value, the wiretapping notification period T3 set as an estimate value, and the wiretapping countering period T4 set as an estimate value; and determines (calculates) the wiretapping period T (=T1+T2+T3+T4). Thus, the wiretapping period T represents the period of time from the start of wiretapping by a wiretapper up to the detection of (the possibility) of wiretapping and execution of the wiretapping countering operation. Meanwhile, instead of determining the wiretapping period T, the wiretapping period determining unit 1101 can determine the wiretapping period T′ (=T+α) that is obtained by adding the margin value α to the wiretapping period T. Then, the system control proceeds to Step S102.

Step S102

The generation rate determining unit 1102 of the determining unit 110 determines the generation rate R (bytes/second) at which the data generating unit 104 generates application data per unit of time and sends it to the encrypting unit 105, and determines the generation rate R′ that is greater than the maximum value of the generation rate R. The generation rate R′ can be set in advance as a predetermined value in the generation rate determining unit 1102. Alternatively, the generation rate R′ can be an actually-measured value (actual measurement value). Then, the system control proceeds to Step S103.

Step S103

The determining unit 110 multiplies the wiretapping period T, which is determined by the wiretapping period determining unit 1101, and the generation rate R′, which is determined by the generation rate determining unit 1102, and determines (calculates) the size L′ that is greater than the size L of the application data which is output during each wiretapping period T by the data generating unit 104 to the encrypting unit 105. The size L′ can be set in advance as a predetermined value in the determining unit 110.

As a result of performing the operations from Steps S101 to S103, the determining unit 110 determines the size L′ of cryptographic keys. As described earlier, the size L′ of cryptographic keys that is determined by the determining unit 110 is greater than the size L of the application data to be encrypted. Hence, encryption of the application data using a cryptographic key having the size L′ implies encryption according to a total encryption method that makes it impossible to decipher the application data.

Explained below with reference to FIGS. 9 and 10 are examples of the operation for repetitive usage of a cryptographic key. Herein, it is assumed that the encrypting unit 105 obtains, in advance from the generating unit 102, a cryptographic key which has the size L′ and which is to be repeatedly used until the detection of the possibility of wiretapping (herein, the cryptographic key is assumed to be the cryptographic key K1 identical to FIG. 7).

Step S111

The encrypting unit 105 starts a timer for measuring the elapse of the wiretapping period T and sets a pointer indicating the start portion for use at the initial position of the cryptographic key K1 (at the leading position of the cryptographic key K1) as illustrating in (a) in FIG. 10. Herein, a “remaining cryptographic key size” indicating the unused portion of the cryptographic key K1 represents the size L′ calculated from the wiretapping period T and the generation rate R′ as described earlier. Then, the system control proceeds to Step S112.

Step S112

The encrypting unit 105 determines whether or not the timer has run beyond the wiretapping period T. If the timer has run beyond the wiretapping period T (Yes at Step S112), then the system control returns to Step S111. However, if the timer has not run beyond the wiretapping period T (No at Step S112), then the system control proceeds to Step S113.

Step S113

The encrypting unit 105 determines whether or not an encryption termination instruction (described later) is received as a wiretapping countering operation from the wiretapping countering unit 109. When the encryption termination instruction is received (Yes at Step S113), the repetitive usage of the cryptographic key is ended. However, if the encryption termination instruction is not received (No at Step S113), the system control proceeds to Step S114.

Step S114

The encrypting unit 105 determines whether or not the application data to be transmitted to the node 2 (transmission data illustrated in (b) in FIG. 10) is received from the data transmitting unit 106. If the application data is received (Yes at Step S114), the system control proceeds to Step S115. However, if the application data is not received (No at Step S114), then the system control returns to Step S112.

Step S115

The encrypting unit 105 deducts the size L of the application data, which is received from the data transmitting unit 106, from the remaining cryptographic key size, and sets the resultant size as the remaining cryptographic key size for the new cryptographic key K1. Then, the system control proceeds to Step S116.

Step S116

The encrypting unit 105 determines whether or not the remaining cryptographic key size is equal to or greater than “0”. If the remaining cryptographic key size is equal to or greater than “0” (Yes at Step S116), the system control proceeds to Step S117. However, if the remaining cryptographic key size is not equal to or greater than “0” (No at Step S116), that is, if there is no remaining portion of the cryptographic key K1 that can be used in encrypting the application data, then the operation for repetitive usage of a cryptographic key is ended.

Step S117

The encrypting unit 105 obtains, from the obtained cryptographic key K1, a cryptographic key having the size L, which is the size of the application data (the transmission data), from the current position of the pointer. Then, as illustrated in (c) in FIG. 10, the encrypting unit 105 moves the pointer, which is set in the cryptographic key K1, by an amount equal to the size L. The system control then proceeds to Step S118.

Step S118

The encrypting unit 105 encrypts the application data, which has the size L, using the cryptographic key having the size L and obtained from the cryptographic key K1; and transmits the cryptographic data to the node 2 via the data transmitting unit 106.

As illustrated in FIG. 7, until the possibility of wiretapping is detected; the encrypting unit 105 performs the operations from Steps S111 to S118 and the cryptographic key K1 that is obtained from the generating unit 102 is repeatedly used during each wiretapping period T to encrypt the application data, and the cryptographic data is transmitted to the node 2 via the data transmitting unit 106.

Returning to the explanation with reference to FIG. 7, given below is the explanation of the wiretapping countering operation.

In FIG. 7, it is illustrated that the wiretapping of the optical data communication channel is started by a wiretapper at the timing tb, and that the wiretapping countering operation is performed at the timing tf. In the example illustrated in FIG. 7, the wiretapping countering operation includes terminating the use of the cryptographic key K1 that was repeatedly used during each wiretapping period T till the timing tf. More particularly, after the wiretapping recognizing unit 107 recognizes the possibility of wiretapping, the wiretapping countering unit 109 receives an instruction for performing the wiretapping countering operation from the wiretapping recognizing unit 107 and sends an encryption termination instruction to the encrypting unit 105. Upon receiving the encryption termination instruction from the wiretapping countering unit 109, the encrypting unit 105 terminates the use of the cryptographic key K1 that was being repeatedly used during each wiretapping period T. As a result of terminating the use of the cryptographic key K1 by the encrypting unit 105, the data transmission operation performed by the data transmitting unit 106 is also stopped. Meanwhile, in FIG. 7, the period of time from the timing tb, at which wiretapping is started, to the timing tf, at which the wiretapping countering operation is performed, cuts across two wiretapping periods T. However, as explained with reference to FIGS. 9 and 10, there is no duplicate use of cryptographic key.

As described above, until the wiretapping detecting unit 207 detects the possibility of wiretapping and the wiretapping countering unit 109 performs the wiretapping countering operation, the encrypting unit 105 performs encryption by repeatedly using the same cryptographic key (in the example illustrated in FIG. 7, the cryptographic key K1) during each wiretapping period T. When the wiretapping detecting unit 207 detects the possibility of wiretapping, the wiretapping countering unit 109 performs the wiretapping countering operation that includes making the encrypting unit 105 to terminate the use of the cryptographic key that was repeatedly used during each wiretapping period T, and makes the data transmitting unit 106 to stop the data transmission operation. As a result, as compared to the case in which the data to be transmitted is encrypted using different cryptographic keys one after another according to the conventional one-time pad method; the amount of consumption of the cryptographic keys, which are shared between and stored in the nodes 1 and 2, can be reduced to a large extent.

For example, if the generation rate for generating application data in the data generating unit 104 of the node 1 is 10 [megabytes/second], and if the operations are performed for 10 [hours] so that the data to be transmitted is encrypted using different cryptographic keys one after another according to the one-time pad method, then the cryptographic keys worth 360 [gigabytes] are consumed as given below in Equation (1).

10 [megabytes/second]×36000 [seconds] (10 [hours])=360 [gigabytes] (1)

In contrast, as described above, in the case of using the same cryptographic key in a repeated manner during each wiretapping period T until the possibility of wiretapping is detected, if the wiretapping period T is set to be equal to 1 [minute] and if the generation rate for generating application data in the data generating unit 104 is 10 [megabytes/second]; when there is no wiretapping during the 10 [hours] of continuous operations, cryptographic keys worth only 0.6 [gigabytes] are consumed as given below in Equation (2).

10 [megabytes/second]×60 [seconds](1 [minute])=0.6 [gigabytes] (2)

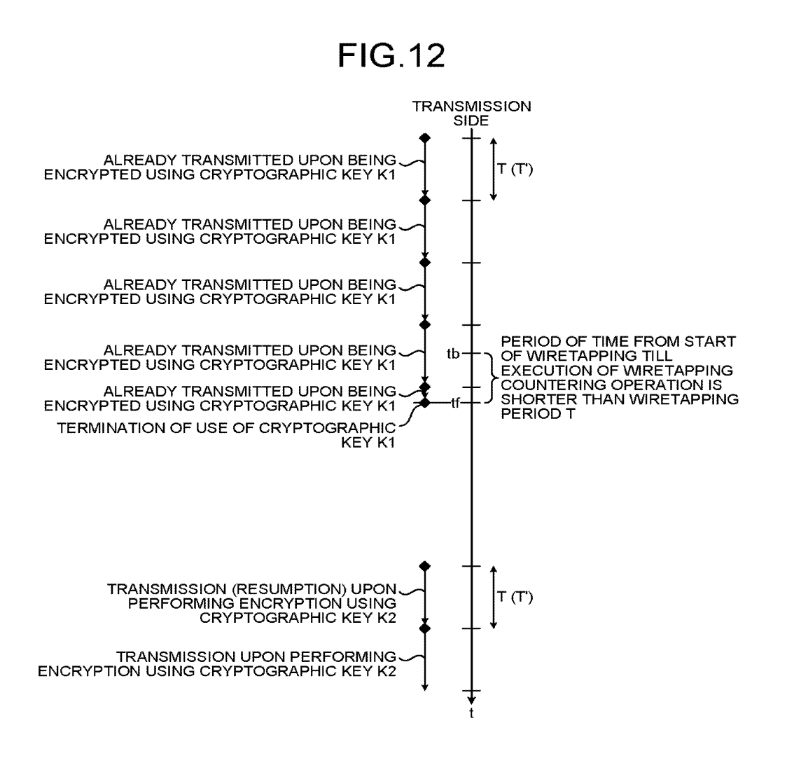

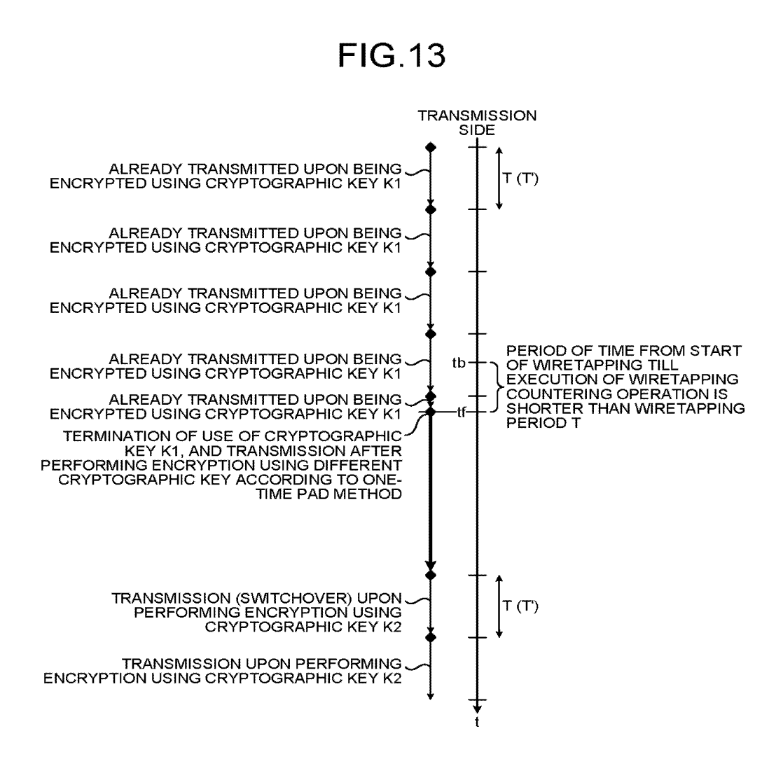

FIG. 11 is a diagram for explaining an operation for switching to the cryptographic key usage according to the one-time pad method after the termination of the repetitive usage of a cryptographic key. FIG. 12 is a diagram for explaining an operation for resuming the repetitive use of another cryptographic key after the termination of the repetitive usage of a particular cryptographic key. FIG. 13 is a diagram for explaining an operation for switching to the one-time pad method and then resuming the repetitive use after the termination of the repetitive usage of a particular cryptographic key. Thus, explained with reference to FIGS. 11 to 13 are the other types of encryption operation other than the encryption operation illustrated in FIG. 7.

In the example illustrated in FIG. 11, the use of the cryptographic key K1, which was repeatedly used during each wiretapping period T until the timing tf at which the wiretapping countering operation is performed, is terminated; and the data transmission is continued by performing encryption according to the one-time pad method using another cryptographic key different from the cryptographic key K1.

More particularly, after the wiretapping recognizing unit 107 recognizes the possibility of wiretapping, the wiretapping countering unit 109 receives an instruction to perform the wiretapping countering operation from the wiretapping recognizing unit 107 and sends an encryption termination instruction to the encrypting unit 105. Upon receiving the encryption termination instruction from the wiretapping countering unit 109, the encrypting unit 105 terminates the use of the cryptographic key K1 that was used during each wiretapping period T. Then, the encrypting unit 105 receives application data from the data generating unit 104; obtains another cryptographic key different from the cryptographic key K1; and performs encryption according to the one-time pad method. The data transmitting unit 106 then transmits the cryptographic data. That is, after terminating the use of the cryptographic key K1, the encrypting unit 105 uses different cryptographic keys one after another and encrypts each piece of application data according to the one-time pad method. In this way, in the case of performing encryption according to the one-time pad method, it becomes necessary to have the cryptographic keys equivalent to the same size as the size of the application data.

As a result of performing the wiretapping countering operation illustrated in FIG. 11, if the possibility of wiretapping is detected, the method is switched to the one-time pad method so as to continue with encryption and data transmission. Hence, although the amount of consumption of the cryptographic keys increases due to the one-time pad method, the data transmission can be continued without interruption.

In the example illustrated in FIG. 12, the use of the cryptographic key K1, which was repeatedly used during each wiretapping period T until the timing tf at which the wiretapping countering operation is performed, is terminated. After that, when it is detected that there is no possibility of wiretapping, another cryptographic key (in FIG. 12, a cryptographic key K2) different from the cryptographic key K1 is used again in a repeated manner during each wiretapping period T.

More specifically, after the wiretapping recognizing unit 107 recognizes the possibility of wiretapping, the wiretapping countering unit 109 receives an instruction to perform the wiretapping countering operation from the wiretapping recognizing unit 107 and sends an encryption termination instruction to the encrypting unit 105. Upon receiving the encryption termination instruction from the wiretapping countering unit 109, the encrypting unit 105 terminates the use of the cryptographic key K1 that was repeatedly used for each wiretapping period T. As a result of terminating the use of the cryptographic key K1 by the encrypting unit 105, the data transmission operation performed by the data transmitting unit 106 is also stopped.

Subsequently, when it is detected that the possibility of wiretapping no longer exists, the wiretapping detecting unit 207 sends a wiretapping end signal to the wiretapping notification transmitting unit 208. Upon receiving the wiretapping end signal from the wiretapping detecting unit 207, the wiretapping notification transmitting unit 208 transmits a wiretapping end notification signal to the wiretapping notification receiving unit 108 of the node 1 via the classical communication channel (such as the optical data communication channel). That is, as a result of transmitting a wiretapping end notification signal to the node 1, the wiretapping notification transmitting unit 208 notifies the node 1 about the fact that the possibility of wiretapping with respect to the data in the optical data communication channel no longer exists. Upon receiving the wiretapping completion notification signal from the wiretapping notification transmitting unit 208, the wiretapping notification receiving unit 108 sends a wiretapping end signal to the wiretapping recognizing unit 107. As a result of receiving the wiretapping end signal from the wiretapping notification receiving unit 108, the wiretapping recognizing unit 107 recognizes that the possibility of wiretapping with respect to the optical data communication channel no longer exists. Upon recognizing that the possibility of wiretapping no longer exists, the wiretapping recognizing unit 107 instructs the wiretapping countering unit 109 that the wiretapping countering operation is no longer required. Upon receiving the instruction from the wiretapping recognizing unit 107 that the wiretapping countering operation is no longer required, the wiretapping countering unit 109 stops performing the wiretapping countering operation, and sends an encryption resumption instruction to the encrypting unit 105.

The encrypting unit 105 obtains the cryptographic key K2 (a second cryptographic key), which has the size L′ but which is different from the cryptographic key K1. Then, the encrypting unit 105 encrypts the application data by repeatedly using the cryptographic key K2 during each wiretapping period T, and transmits cryptographic data to the node 2 via the data transmitting unit 106. Meanwhile, since the decrypting unit 205 has already obtained the information about the size L′ from the encrypting unit 105, the decrypting unit 205 obtains the cryptographic key K2 (the cryptographic key shared with the node 1), which has the size L′ but which is different from the cryptographic key K1. Then, the decrypting unit 205 decrypts the received cryptographic data by repeatedly using the cryptographic key K2 during each wiretapping period T.

In the example illustrated in FIG. 12, while the wiretapping countering operation is being performed (while the repetitive use of the cryptographic key K1 is terminated), if it is detected that the possibility of wiretapping no longer exists, the encrypting unit 105 performs encryption by again repeatedly using same cryptographic key (a cryptographic key different from the cryptographic key K1) during each wiretapping period T. Thus, as long as there is a possibility of wiretapping, the data transmission is terminated so that the data can be prevented from being wiretapped. When the possibility of wiretapping no longer exists, encryption is performed by again repeatedly using same cryptographic key (a cryptographic key different from the cryptographic key K1). That enables achieving reduction in the amount of consumption of the cryptographic keys.

In the example illustrated in FIG. 13, the use of the cryptographic key K1, which was repeatedly used during each wiretapping period T until the timing tf at which the wiretapping countering operation is performed, is terminated; and, as long as there is a possibility of wiretapping, data transmission is continued by performing encryption according to the one-time pad method using another cryptographic key different from the cryptographic key K1. When it is detected that the possibility of wiretapping no longer exists, another cryptographic key (in FIG. 13, the cryptographic key K2) (a second-type cryptography key) that is different from the cryptographic key K1 is used in a repeated manner during each wiretapping period T. That is, the example of operations illustrated in FIG. 13 is a combination of the example of operations illustrated in FIG. 11 and the example of operations illustrated in FIG. 12.

In the example illustrated in FIG. 13, during the period of time in which there is no possibility of wiretapping, the application data is encrypted using the same cryptographic key in a repeated manner. That enables achieving reduction in the amount of consumption of the cryptographic keys. On the other hand, during the period of time in which there is a possibility of wiretapping, the method is switched to the one-time pad method so as to continue with encryption and data transmission. Thus, the data transmission can be continued without interruption.

For example, as explained in the first embodiment, until the possibility of wiretapping is detected, the same cryptographic key K1 is repeatedly used in each wiretapping period T (set to 1 [minute]). When the possibility of wiretapping is detected, encryption is performed by switching to the conventional one-time pad method. Consider a case in which, since the detection of the possibility of wiretapping, it takes 3 [hours] to detect the fact that the possibility of wiretapping no longer exists; and in which the cryptographic key K2 that is different from the cryptographic key K2 is used again in a repeated manner during each wiretapping period T. Moreover, it is assumed that the generation rate for generating application data in the data generating unit 104 of the node 1 is 10 [megabytes/second], and that the operations are performed for 10 [hours] in all. In this case, as compared to the amount of consumption of 360 [gigabytes] of cryptographic keys as given earlier in Equation (1), cryptographic keys worth only 109.2 [gigabytes] are consumed as given below in Equation (3).

0.6 [gigabytes]+10 [megabytes/second]×10800 [seconds](3 [hours])+0.6 [gigabytes]=109.2 [gigabytes] (3)

### First Modification Example

Regarding a first modification example, the explanation is given with the focus on the differences with the communication system 100 according to the first embodiment. In the first embodiment, the node 1 functioning as a transmitter includes a data transmitting unit (in FIG. 3, the data transmitting unit 106), while the node 2 functioning as a receiver includes a data receiving unit (in FIG. 3, the data receiving unit 206). In the first modification example, the explanation is given for a configuration in which the node functioning as a transmitter includes a data receiving unit, and the node functioning as a receiver includes a data transmitting unit.

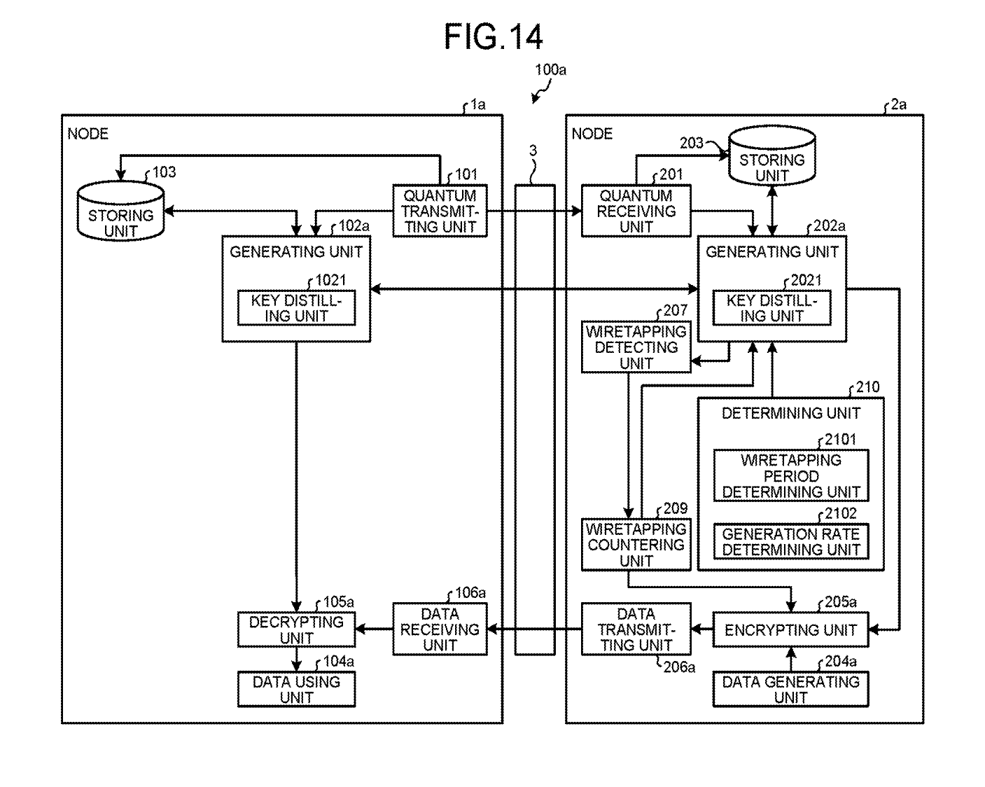

FIG. 14 is a diagram illustrating an exemplary functional block configuration of the nodes according to the first modification example of the first embodiment. Thus, explained with reference to FIG. 14 is a functional block configuration of nodes 1a and 2a in a communication system 100a.

As illustrated in FIG. 14, in the communication system 100a, the node 1a (a communication device) includes the quantum transmitting unit 101, a generating unit 102a (a second obtaining unit), the storing unit 103 (a second storing unit), a data using unit 104a, a decrypting unit 105a (a decrypting unit), and a data receiving unit 106a (a receiving unit). Herein, the quantum transmitting unit 101 and the storing unit 103 have identical functions to the quantum transmitting unit 101 and the storing unit 103, respectively, of the node 1 illustrated in FIG. 3 according to the first embodiment.

The generating unit 102a is a functional unit that receives information about the length (the size L′) of the cryptographic key via the optical data communication channel from a generating unit 202a and that generates a cryptographic key for the purpose of encrypting the data received by the data receiving unit 106a by obtaining a cryptographic key having the size L′ from the storing unit 103. The generating unit 102a includes the key distilling unit 1021, which has identical functions to the key distilling unit 1021 illustrated in FIG. 3 of the node 1 according to the first embodiment.

The data using unit 104a is an application running in the node 1a for handling a variety of data and is a functional unit that receives application data that was received by the decrypting unit 105a from the node 2a, and makes use of the application data.

The decrypting unit 105a is, as described later, a functional unit that receives cryptographic data from the data receiving unit 106a, that obtains the cryptographic key from the generating unit 102a, and that decrypts the cryptographic data using the cryptographic key. Moreover, the decrypting unit 105a sends application data, which is obtained by decrypting the cryptographic data, to the data using unit 104a.

The data receiving unit 106a is a functional unit that converts optical signals, which are received from a data transmitting unit 206a via the optical data communication channel, into cryptographic data and that sends it to the decrypting unit 105a. The data receiving unit 106a is implemented by the optical processing device 85 illustrated in FIG. 2.

As illustrated in FIG. 14, in the communication system 100a, the node 2a (a communication system) includes the quantum receiving unit 201 (a sharing unit), the generating unit 202a (a first obtaining unit), the storing unit 203 (a first storing unit), a data generating unit 204a, an encrypting unit 205a (an encrypting unit), the data transmitting unit 206a, the wiretapping detecting unit 207 (a recognizing unit), a wiretapping countering unit 209, and a determining unit 210 (a second determining unit). The quantum receiving unit 201 and the storing unit 203 have identical functions to the functions of the quantum receiving unit 201 and the storing unit 203, respectively, of the node 2 illustrated in FIG. 3 according to the first embodiment.

The generating unit 202a is a functional unit that generates a cryptographic key, which is to be used in encrypting the data transmitted from the data transmitting unit 206a, by obtaining a cryptographic key, which has the length (the size L′) determined by the determining unit 210 (described later), from the storing unit 203. Moreover, the generating unit 202a transmits the information about the size L′, which represents the length of cryptographic keys as determined by the determining unit 210, to the generating unit 102a via the optical data communication channel. The generating unit 202a includes the key distilling unit 2021 (a key distilling unit), which has identical functions to the functions of the key distilling unit 2021 of the node 2 illustrated in FIG. 3 according to the first embodiment.

The data generating unit 204a is an application running in the node 2a for handling a variety of data and is a function unit that sends application data, which is to be sent to the node 1a, to the encrypting unit 205a.

The encrypting unit 205a is a functional unit that receives application data from the data generating unit 204a, that obtains the cryptographic key from the generating unit 202a, and that encrypts the application data using the cryptographic key. Then, the encrypting unit 205a sends the encrypted application data (cryptographic data) to the data transmitting unit 206a.

The data transmitting unit 206a is a functional unit that converts the cryptographic data, which is received from the encrypting unit 205a, into optical signals and that transmits the optical signals of the cryptographic data to the data receiving unit 106a of the node 1 via the optical data communication channel of the optical fiber link 3. The data transmitting unit 206a is implemented by the optical processing device 85 illustrated in FIG. 2.

The wiretapping detecting unit 207 is a functional unit that obtains the error rate of the photon communication channel (the quantum communication channel) as calculated during the key distillation operation performed by the key distilling unit 2021 of the generating unit 202a, that performs the wiretapping determination operation based on the error rate, and that detects the possibility of wiretapping by a wiretapper. For example, when the obtained error rate is greater than a predetermined threshold value, the wiretapping detecting unit 207 detects that there is a possibility of wiretapping. When the possibility of wiretapping is detected, the wiretapping detecting unit 207 sends a wiretapping detection signal to the wiretapping countering unit 209. Thus, herein, the data (such as application data) communicated using the optical data communication channel is the target for wiretapping intended by the wiretapper; and the possibility of wiretapping with respect to the data in the optical data communication channel is detected based on the error rate of the photon string in the optical photon communication channel that is formed in the same optical fiber link 3 as a result of implementing the coexistence technology.

The wiretapping countering unit 209 is a functional unit that receives an instruction to perform the wiretapping countering operation from the wiretapping detecting unit 207 and that performs the wiretapping countering operation.

The determining unit 210 is a functional unit that determines the size L′ that is greater than the size L of the application data sent by the data generating unit 204a to the encrypting unit 205 during the wiretapping period T that includes the time slot within which the data is at risk of being actually wiretapped in the optical data communication channel. Herein, the method of determining the size L′ is identical to the first embodiment. Meanwhile, the determining unit 210 includes a wiretapping period determining unit 2101 (a first determining unit) and a generation rate determining unit 2102.

The wiretapping period determining unit 2101 is a functional unit that determines the wiretapping period T that includes the time slot within which the data that is at risk of being actually wiretapped is transmitted using the optical data communication channel. The method of determining the wiretapping period T is identical to the first embodiment except for the fact that the wiretapping communication period T3 need not be taken into account.

The generation rate determining unit 2102 is a functional unit that determines the generation rate R′ that is greater than the maximum value of the generation rate R at which the data generating unit 204a generates application data per unit of time and sends it to the encrypting unit 205a. The method of generating the generation rate R′ is identical to the first embodiment.

Given below is the explanation of the operation for repetitive usage of a cryptographic key in the communication system 100a and the wiretapping countering operation in the case of detection of the possibility of wiretapping in the communication system 100a.

In an identical manner to the operations illustrated in FIG. 7 according to the first embodiment, in the communication system 100a according to the first modification example, during each wiretapping period T determined by the wiretapping period determining unit 2101 of the determining unit 210, the same cryptographic key K1 (a first-type cryptographic key) that is generated and shared between the nodes 1a and 2a is used in a repeated manner. That is, in the node 2a, the encrypting unit 205a repeatedly uses the cryptographic key K1, which is obtained from the generating unit 202a, during each wiretapping period T; encrypts the application data; and transmits the cryptographic data to the node 1a via the data transmitting unit 206a. In the node 1a, the decrypting unit 105a repeatedly uses the cryptographic key K1 (the cryptographic key shared with the node 2a), which is obtained from the generating unit 102a, during each wiretapping period T and decrypts the received cryptographic data.

The encrypting unit 205a obtains, from the generating unit 202a, a cryptographic key having the size L′ that is greater than the size L of the application data which is output during each wiretapping period T by the data generating unit 204a to the encrypting unit 205a. As described earlier, the wiretapping period T is determined by the wiretapping period determining unit 2101 of the determining unit 210, and the size L′ is determined by the determining unit 210. The determining unit 210 sends the information about the size L′ and the wiretapping period T to the generating unit 202a. Then, for example, via the optical data communication channel of the optical fiber link 3 (a physical medium), the generating unit 202a transmits the information about the size L′ and the wiretapping period T to the generating unit 102a. With that, the decrypting unit 105a can obtain the cryptographic key having the size L′ from the generating unit 102a, and can repeatedly use the cryptographic key having the size L′ during each wiretapping period T.

The wiretapping countering operation includes terminating the use of the cryptographic key K1 that was repeatedly used during each wiretapping period T till the timing tf (see FIG. 7). More particularly, after the wiretapping detecting unit 207 recognizes the possibility of wiretapping, the wiretapping countering unit 209 receives an instruction for performing the wiretapping countering operation from the wiretapping detecting unit 207 and sends an encryption termination instruction to the encrypting unit 205a. Upon receiving the encryption termination instruction from the wiretapping countering unit 209, the encrypting unit 205a terminates the use of the cryptographic key K1 that was being repeatedly used during each wiretapping period T. As a result of terminating the use of the cryptographic key K1 by the encrypting unit 205a, the data transmission operation performed by the data transmitting unit 206a is also stopped.

In this way, even in a configuration in which the node 1a functioning as a transmitter includes a data receiving unit and the node 2a functioning as a receiver includes a data transmitting unit, the effect is identical to the effect achieved in the first embodiment. That is, in the first modification example, until the wiretapping detecting unit 207 detects the possibility of wiretapping and the wiretapping countering unit 209 performs the wiretapping countering operation, the encrypting unit 205a performs encryption by repeatedly using the same cryptographic key (in the example illustrated in FIG. 7, the cryptographic key K1) during each wiretapping period T. When the wiretapping detecting unit 207 detects the possibility of wiretapping, the wiretapping countering unit 209 performs the wiretapping countering operation that includes making the encrypting unit 205a to terminate the use of the cryptographic key that was repeatedly used during each wiretapping period T, and making the data transmitting unit 206a to stop the data transmission operation. As a result, as compared to the case in which the data to be transmitted is encrypted using different cryptographic keys one after another according to the conventional one-time pad method; the amount of consumption of the cryptographic keys, which are shared between and stored in the nodes 1a and 2a, can be reduced to a large extent.

Meanwhile, the other encryption-related operations explained with reference to FIGS. 11 to 13 according to the first embodiment can also be implemented in the communication system 100a according to the first modification example.

Moreover, the configuration can alternatively be such that the node 1a functioning as a transmitter as well as the node 2a functioning as a receiver includes a data transmitting unit and a data receiving unit. In that case, it is desirable that the cryptographic key used in encrypting the data to be transmitted from the node 1a (i.e., the cryptographic key used in decrypting the data received by the node 2a) is different from the cryptographic key used in encrypting the data to be transmitted from the node 2a (i.e., the cryptographic key used in decrypting the data received by the node 1a). As a result, in case a wiretapper performs wiretapping with respect to the optical data communication channel, it becomes possible to avoid a situation in which a plurality of pieces of application data encrypted using the same cryptographic key is wiretapped.

### Second Modification Example

Regarding a second modification example, the explanation is given with the focus on the differences with the communication system 100 according to the first embodiment. Herein, the communication system according to the second modification example is assumed to have an identical configuration to the configuration of the communication system 100 illustrated in FIGS. 1 to 3 according to the first embodiment.

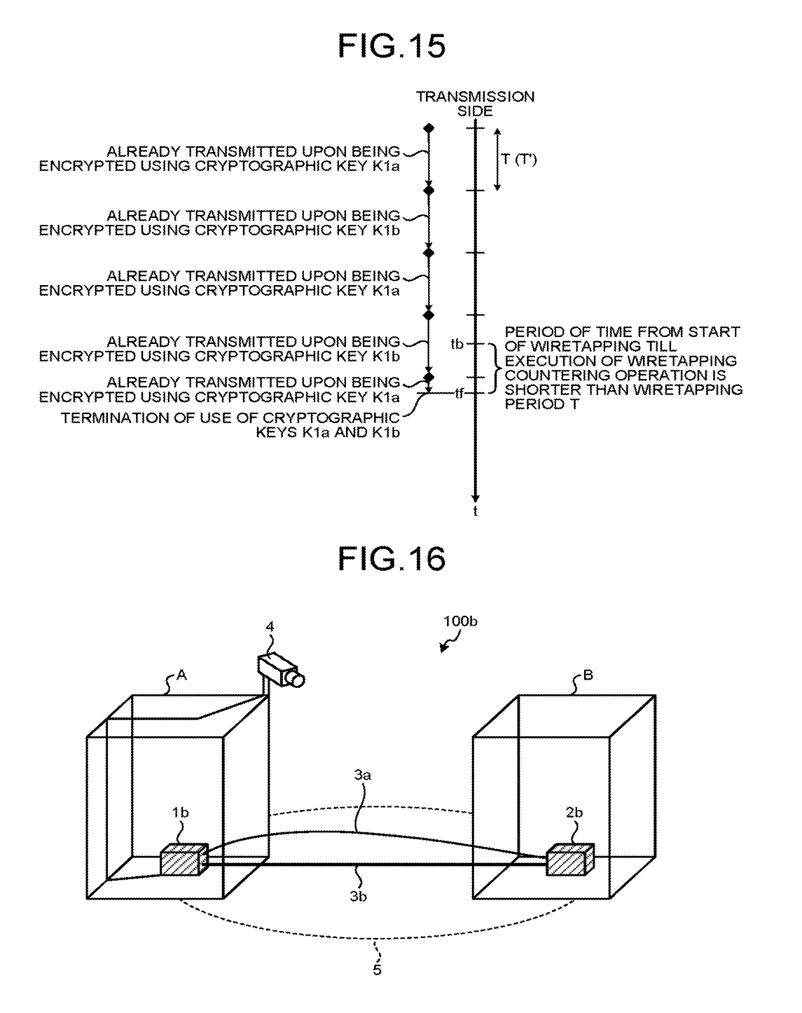

FIG. 15 is a diagram for explaining an operation for repetitive usage of two types of cryptographic keys. Thus, explained with reference to FIG. 15 is an operation for repetitive usage of a cryptographic key.

As illustrated in FIG. 7 and in FIGS. 11 to 13, in the communication system 100 according to the first embodiment, the same cryptographic key K1 is repeatedly used during each wiretapping period T determined by the wiretapping period determining unit 1101 of the determining unit 110. In the communication system according to the second modification example, as illustrated in FIG. 15, during each wiretapping period T determined by the wiretapping period determining unit 1101 of the determining unit 110, cryptographic keys K1a and K1b, which are generated by and shared between the nodes 1 and 2, are repeatedly used in an alternate manner. That is, the encrypting unit 105 of the node 1 encrypts the application data by repeatedly using the cryptographic keys K1a and K1b, which have the size L′ and which are obtained from the generating unit 102, in an alternate manner during each wiretapping period T; and transmits the cryptographic data to the node 2 via the data transmitting unit 106. The decrypting unit 205 of the node 2 decrypts the received cryptographic data by repeatedly using the cryptographic keys K1a and K1b, which have the size L′ and which are obtained from the generating unit 202 (i.e., the cryptographic keys shared with the node 1), in an alternate manner during each wiretapping period T.

When the wiretapping recognizing unit 107 recognizes the possibility of wiretapping, the wiretapping countering unit 109 receives an instruction for performing the wiretapping countering operation from the wiretapping recognizing unit 107 and sends an encryption termination instruction to the encrypting unit 105. Upon receiving the encryption termination instruction from the wiretapping countering unit 109, the encrypting unit 105 terminates the use of the cryptographic keys K1a and K1b that were being repeatedly used during each wiretapping period T. As a result of terminating the use of the cryptographic keys K1a and K1b by the encrypting unit 105, the data transmission operation performed by the data transmitting unit 106 is also stopped.

As a result of performing such operations, it becomes possible to achieve an identical effect to the effect achieved in the first embodiment.

### Second Embodiment

Regarding a communication system according to a second embodiment, the explanation is given with the focus on the differences with the communication system 100 according to the first embodiment. In the first embodiment, the possibility of wiretapping of data in the classical communication channel (the optical data communication channel) is detected based on the error rate of the photon communication channel formed in the optical fiber link 3. In contrast, in the second embodiment, the explanation is given for an operation for detecting the possibility of wiretapping by capturing a monitoring area using an imaging device.

FIG. 16 is a diagram illustrating an exemplary arrangement in the communication system according to the second embodiment. Thus, explained with reference to FIG. 16 is a configuration of a communication system 100b and an exemplary arrangement therein.

As illustrated in FIG. 16, the communication system 100b includes a node 1b (a communication device) functioning as a transmitter, a node 2b (a communication device) functioning as a receiver, a quantum communication channel 3a, a classical communication channel 3b (a data communication channel), and an imaging device 4 (a detecting unit).

The node 1b is a transmitter that transmits, to the node 2b via the quantum communication channel 3a, a photon string that is made of laser-generated single photons which serve as the basis for generating cryptographic keys. In the example illustrated in FIG. 16, the node 1b is installed inside a building A. Moreover, the node 1b performs a key distillation operation (i.e., a sifting operation, an error correction operation, and a privacy amplification operation) based on the photon string that is transmitted; and generates a cryptographic key. Furthermore, during the key distillation operation, the node 1b exchanges control information (not the single photons but general-purpose digital data) with the node 2b via the classical communication channel 3b.

The node 2b is a receiver that receives, from the node 1b via the quantum communication channel 3a, the photon string made of single photons that serve as the basis for generating cryptographic keys. In the example illustrated in FIG. 16, the node 2b is installed inside a building B. Moreover, the node 2b performs a key distillation operation (i.e., a sifting operation, an error correction operation, and a privacy amplification operation) based on the photon string that is received; and generates a cryptographic key that is identical to the cryptographic key generated by the node 1b. Furthermore, during the key distillation operation, the node 2b exchanges control information with the node 1b via the classical communication channel 3b.

The quantum communication channel 3a is an optical fiber used in sending and receiving photons. The classical communication channel 3b is a communication channel used in sending and receiving the control information and the application data. Herein, the classical communication channel 3b is implemented using a communication cable such as an optical fiber or an Ethernet (registered trademark) cable that enables sending and receiving normal digital data.

The imaging device 4 is a camera device that captures the condition of a monitoring area 5. The imaging device 4 is communicably connected to the node 1b either in a wired manner or in a wireless manner. The data captured by the imaging device 4 can be in the form of still images or moving images taken at predetermined intervals. In the following explanation, the data captured by the imaging device 4 is sometimes simply called “image information” (a detection result). As illustrated in FIG. 16, the monitoring area 5 that is the capturing target of the imaging device 4 includes the quantum communication channel 3a and the classical communication channel 3b. However, herein, it is ensured that at least the classical communication channel 3b, which is used in communicating the control information and the application data, is included in the monitoring area 5. Thus, the monitoring area 5 that is the capturing target of the imaging device 4 is formed close to the classical communication channel 3b.

The single photons output by the node 1b are transmitted to the node 2b via the quantum communication channel 3a. The communication data such as the control information and the application data is communicated between the nodes 1b and 2b via the classical communication channel 3b.

Meanwhile, in the communication system 100b, during the key distillation operation that is required for the purpose of sharing cryptographic keys between the nodes 1b and 2b, the necessary control information either can be exchanged using the classical communication channel 3b as described above or can be exchanged using a separate dedicated channel formed in the quantum communication channel 3a, which is an optical fiber for sending and receiving photons, by implementing the WDM technology.

Meanwhile, the data communicated using the classical communication channel 3b can be any type of data. As described earlier, the control information required in the key distillation operation and the application data can be exchanged or some other general-purpose data can be exchanged using the classical communication channel 3b.

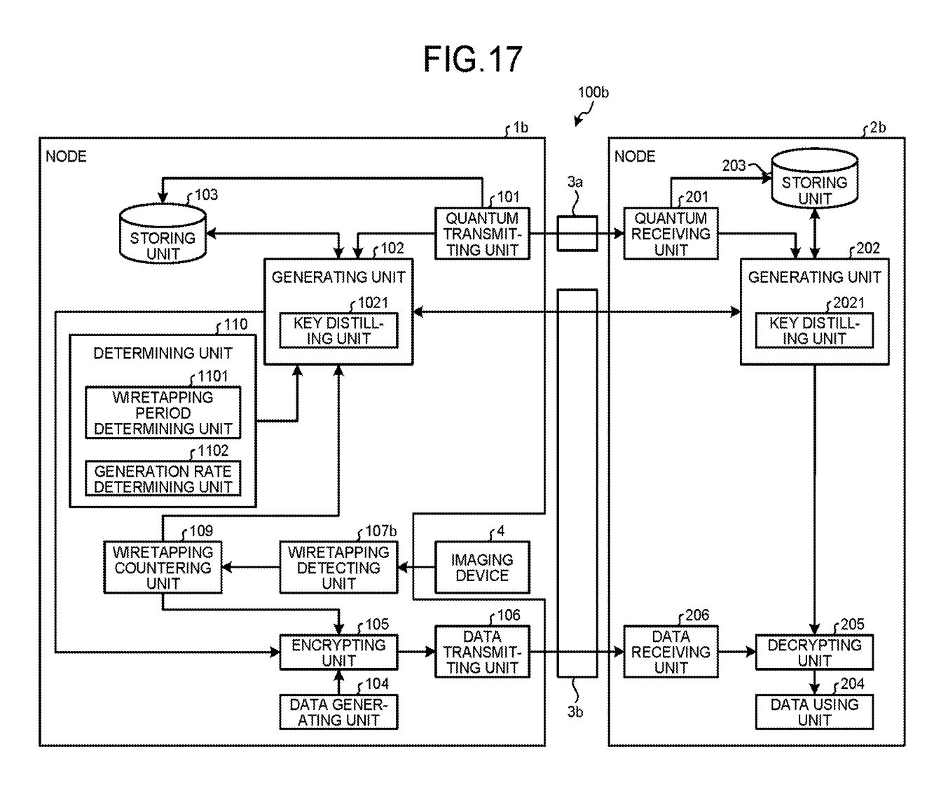

FIG. 17 is a diagram illustrating an exemplary functional block configuration of the nodes according to the second embodiment. Thus, explained with reference to FIG. 17 is a functional block configuration of the nodes 1b and 2b.

As illustrated in FIG. 17, the node 1b includes the quantum transmitting unit 101 (a sharing unit), the generating unit 102 (a first obtaining unit), the storing unit 103 (a first storing unit), the data generating unit 104, the encrypting unit 105 (an encrypting unit), the data transmitting unit 106, a wiretapping detecting unit 107b (a recognizing unit), the wiretapping countering unit 109, and the determining unit 110 (a second determining unit). Herein, the quantum transmitting unit 101, the generating unit 102, the storing unit 103, the data generating unit 104, the encrypting unit 105, and the data transmitting unit 106 have identical functions to the functions of the quantum transmitting unit 101, the generating unit 102, the storing unit 103, the data generating unit 104, the encrypting unit 105, and the data transmitting unit 106, respectively, of the node 1 illustrated in FIG. 3 according to the first embodiment.

The wiretapping detecting unit 107b performs image analysis with respect to the image information captured by the imaging device 4, and detects a person or an object that may wiretap the data in the classical communication channel 3b within the monitoring area 5. Thus, when a person or an object that may perform wiretapping is detected as a result of performing image analysis with respect to the image information, the wiretapping detecting unit 107b detects the possibility of wiretapping. When the possibility of wiretapping is detected, the wiretapping detecting unit 107b instructs the wiretapping countering unit 109 to perform a wiretapping countering operation.

The wiretapping countering unit 109 is a functional unit that performs, upon receiving the instruction to perform the wiretapping countering operation from the wiretapping detecting unit 107b, the wiretapping countering operation. The specific contents of the wiretapping countering operation are identical to the first embodiment.

The determining unit 110 is a functional unit that determines the size L′ that is greater than the size L of the application data sent by the data generating unit 104 to the encrypting unit 105 during the wiretapping period T that includes the time slot within which the data that is at risk of being actually wiretapped is transmitted using the classical communication channel 3b. The method of determining the size L′ is identical to the first embodiment. The determining unit 110 includes the wiretapping period determining unit 1101 (a first determining unit) and the generation rate determining unit 1102.

The wiretapping period determining unit 1101 is a functional unit that determines the wiretapping period T that includes the time slot within which the data is at risk of actually being wiretapped in the classical communication channel 3b. Regarding the method of determining the wiretapping period T, the explanation is given later.

The generation rate determining unit 1102 is a functional unit that determines the generation rate R′ greater than the maximum value of the generation rate R at which the data generating unit 104 generates application data per unit of time and sends it to the encrypting unit 105. The method of generating the generation rate R′ is identical to the first embodiment.

As illustrated in FIG. 17, the node 2b of the communication system 100b includes the quantum receiving unit 201, the generating unit 202 (a second obtaining unit), the storing unit 203 (a second storing unit), the data using unit 204, the decrypting unit 205 (a decrypting unit), and the data receiving unit 206 (a receiving unit). Thus, the functions of all constituent elements of the node 2b are identical to the functions of the constituent elements of the node 2 illustrated in FIG. 1 according to the first embodiment.

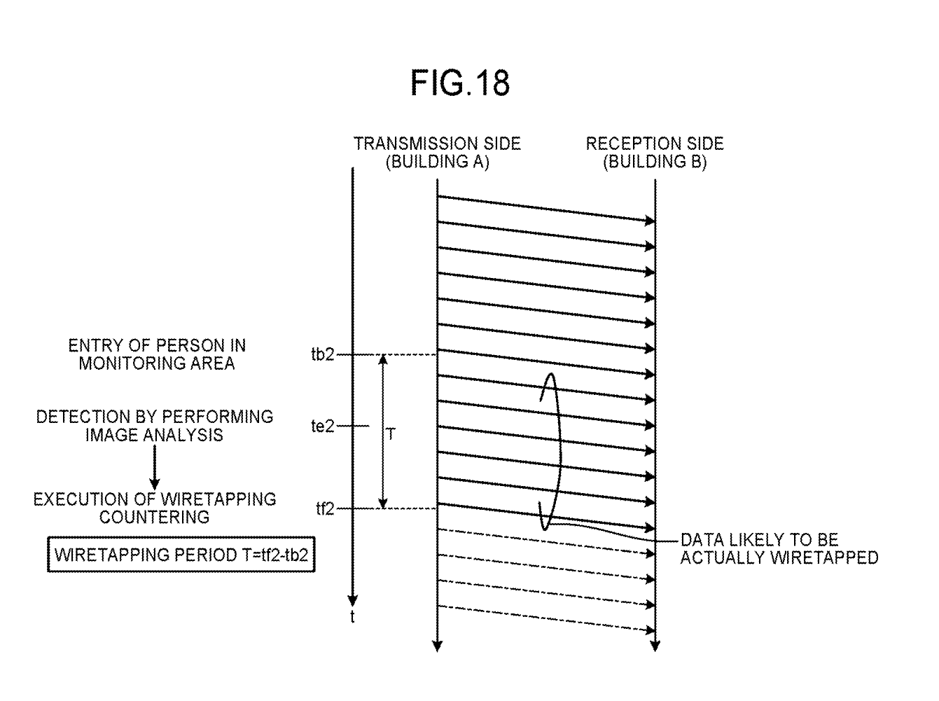

FIG. 18 is a diagram for explaining a wiretapping period implied in the second embodiment. Thus, with reference to FIG. 18, given below is the explanation about the wiretapping period T that is determined by the wiretapping period determining unit 1101 of the determining unit 110.

As illustrated in FIG. 18, assume that a person or an object enters the monitoring area 5 at a timing tb2. Then, the wiretapping detecting unit 107b performs image analysis with respect to the image information captured by the imaging device 4, and detects the possibility of wiretapping with respect to the classical communication channel 3b at a timing te2.

When the possibility of wiretapping is detected, the wiretapping detecting unit 107b instructs the wiretapping countering unit 109 to perform a wiretapping countering operation. Upon receiving the instruction to perform a wiretapping countering operation from the wiretapping detecting unit 107b, the wiretapping countering unit 109 performs the wiretapping countering operation. As illustrated in FIG. 18, a timing tf2 represents the timing at which the wiretapping countering unit 109 performs the wiretapping countering operation.

The wiretapping period determining unit 1101 of the determining unit 110 determines, as the wiretapping period T, a period of time equal to or greater than the period of time between the timings tb2 and tf2. In that case, the period of time between the timings tb2 and tf2 varies according to the quality of the imaging device 4, or the image processing capacity, or the communication quality between the imaging device 4 and the wiretapping detecting unit 107b. For that reason, although the period of time from the timing tb2 to the timing tf2 varies in reality, the worst-case value can be set as the wiretapping period T. Of the wiretapping period T, since the timing at which the wiretapping is actually started comes after the timing tb2, the period of time in which the data is at risk of being actually wiretapped is included in the wiretapping period T. Meanwhile, in an identical manner to the first embodiment, instead of determining the wiretapping period T, the wiretapping period determining unit 1101 can determine the wiretapping period T′ (=T+α) obtained by adding the margin value α in the wiretapping period T.

Alternatively, the wiretapping period T can be determined using actually-measured values (actual measurement values). Still alternatively, the wiretapping period T can be allowed to be input using an input unit (not illustrated). Still alternatively, the wiretapping period T (or the wiretapping period T′) can be set in advance as a predetermined value in the wiretapping period determining unit 1101.

As illustrated in FIG. 18, in the wiretapping period T after the timing tb2, although there is a possibility of wiretapping, it is believed that no wiretapping has occurred in the period of time before the timing tb2. However, as described later, after the timing tb2, even if the data transmitted during the wiretapping period T is wiretapped, it is impossible for the wiretapper to decrypt the data because a cryptographic key having the same length as the data length is used according to the one-time pad method. Thus, after the timing tf2, unless the cryptographic key that has been used in the period between the timings tb2 and tf2 is reused, the data wiretapped in the period between the timings tb2 and tf2 cannot be decrypted.

Moreover, if wiretapping has not occurred before the timing tb2, even if the cryptographic key that is used in the wiretapping period T from the timing tb2 to the timing tf2 was used before the timing tb2 too, the wiretapper who started wiretapping after the timing tb2 does not obtain the data encrypted by the same cryptographic key before the timing tb2. Thus, the cryptographic key used in the wiretapping period T from the timing tb2 to the timing tf2 is identical to a disposable cryptographic key used only once to the wiretapper.

Meanwhile, the operation for repetitive usage of a cryptographic key as performed in the communication system 100b according to the second embodiment is identical to the operation performed in the communication system 100 according to the first embodiment.

Given below is the explanation of the wiretapping countering operation according to the second embodiment. In FIG. 18, it is illustrated that a person or an object enters the monitoring area 5 at the timing tb2 and the wiretapping countering operation is performed at the timing tf2. In the second embodiment too, in an identical manner to the example illustrated in FIG. 7 according to the first embodiment, the wiretapping countering operation includes terminating the use of the cryptographic key K1 (a first cryptographic key) that was repeatedly used during each wiretapping period T till the timing tf2. More particularly, after the wiretapping recognizing unit 107 recognizes the possibility of wiretapping, the wiretapping countering unit 109 receives an instruction for performing the wiretapping countering operation from the wiretapping recognizing unit 107 and sends an encryption termination instruction to the encrypting unit 105. Upon receiving the encryption termination instruction from the wiretapping countering unit 109, the encrypting unit 105 terminates the use of the cryptographic key K1 that was being repeatedly used during each wiretapping period T. As a result of terminating the use of the cryptographic key K1 by the encrypting unit 105, the data transmission operation performed by the data transmitting unit 106 is also stopped.

In this way, the wiretapping detecting unit 107b performs image analysis with respect to the image information captured by the imaging device 4, and detects the possibility of wiretapping. Until the wiretapping countering unit 109 performs the wiretapping countering operation, the encrypting unit 105 performs encryption using the same cryptographic key in a repeated manner during each wiretapping period T. When the wiretapping detecting unit 107b detects the possibility of wiretapping, the wiretapping countering unit 109 performs the wiretapping countering operation that includes making the encrypting unit 105 to terminate the use of the cryptographic key that was repeatedly used during each wiretapping period T and making the data transmitting unit 106 to stop the data transmission operation. As a result, as compared to the case in which the data to be transmitted is encrypted using different cryptographic keys one after another according to the conventional one-time pad method; the amount of consumption of the cryptographic keys, which are shared between and stored in the nodes 1b and 2b, can be reduced to a large extent.

Meanwhile, the other encryption-related operations explained with reference to FIGS. 11 to 13 according to the first embodiment can also be implemented in the communication system 100b according to the second embodiment. Particularly, as illustrated in FIGS. 12 and 13, the operation for resuming the repetitive use of the same cryptographic key is performed in the following specific manner. The wiretapping detecting unit 107b performs image analysis with respect to the image information captured by the imaging device 4, and detects that a person or an object that may wiretap the data in the classical communication channel 3b within the monitoring area 5 is no longer present. Thus, when a person or an object that may perform wiretapping is detected to be no longer present as a result of performing image analysis with respect to the image information, the wiretapping detecting unit 107b detects that the possibility of wiretapping no longer exists. When it is detected that the possibility of wiretapping no longer exists, the wiretapping detecting unit 107b instructs the wiretapping countering unit 109 that the wiretapping countering operation is no longer required. Upon receiving the instruction from the wiretapping detecting unit 107b that the wiretapping countering operation is no longer required, the wiretapping countering unit 109 stops performing the wiretapping countering operation, and sends an encryption resumption instruction to the encrypting unit 105.

The encrypting unit 105 obtains the cryptographic key K2, which has the size L′ but which is different from the cryptographic key K1, from the generating unit 102. Then, the encrypting unit 105 encrypts the application data by repeatedly using the cryptographic key K2 during each wiretapping period T, and transmits cryptographic data to the node 2 via the data transmitting unit 106. Meanwhile, since the decrypting unit 205 has already obtained the information about the size L′ from the encrypting unit 105, the decrypting unit 205 obtains the cryptographic key K2 (the cryptographic key shared with the node 1), which has the size L′ but which is different from the cryptographic key K1. Then, the decrypting unit 205 decrypts the received cryptographic data by repeatedly using the cryptographic key K2 during each wiretapping period T.

Meanwhile, in the second embodiment, although the imaging device 4 is assumed to be a camera device, that is not the only possible case. Alternatively, for example, the imaging device 4 can be a sensor device such as a human sensor.

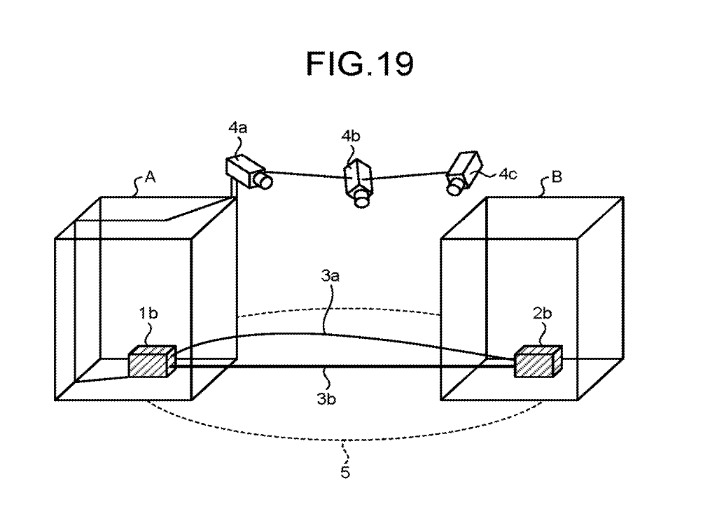

FIG. 19 is a diagram illustrating an example in which the communication system according to the second embodiment includes a plurality of imaging devices. The communication system 100b illustrated in FIG. 16 includes a single imaging device 4. However, that is not the only possible case. Alternatively, as illustrated in FIG. 19, it is possible to have a plurality of imaging devices (in the example illustrated in FIG. 19, imaging devices 4a to 4c) (detecting units) that are connected in a wired manner or a wireless manner to be able to communicate data. If such a plurality of imaging devices is used, it becomes possible to enhance the detection accuracy of the wiretapping detecting unit 107b for detecting a person or an object that may wiretap the data in the classical communication channel 3b within the monitoring area 5.

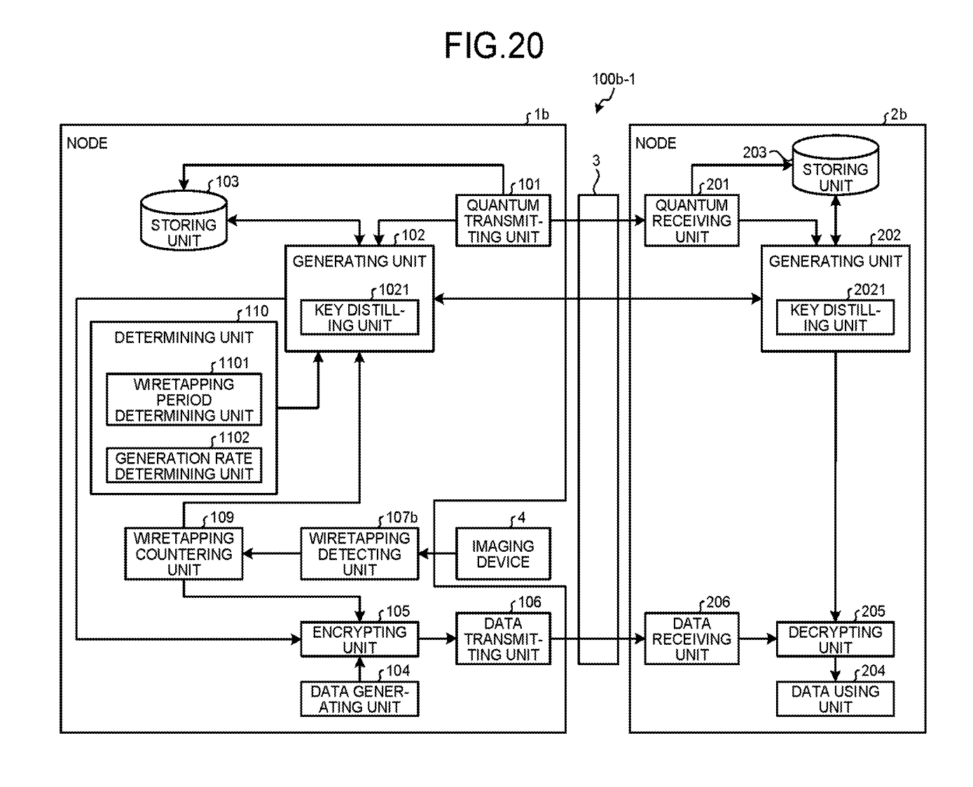

FIG. 20 is a diagram illustrating an example in which, in the communication system according to the second embodiment, the quantum communication channel and the classical communication channel are configured in the same optical fiber. In FIG. 17, the quantum communication channel 3a for sending and receiving photons and the classical communication channel 3b for sending and receiving control information and application data are illustrated as separate communication channels. However, that is not the only possible case. Alternatively, as illustrated in a communication system 100b-1 in FIG. 20, in the optical fiber link 3 (a physical medium) representing a single optical fiber, the WDM technology is implemented so as to form a photon communication channel having the same function as the quantum communication channel 3a and to form an optical data communication channel having the same function as the classical communication channel 3b. In that case, the monitoring area 5, which is the capturing target of the imaging device 4, can be formed to include the optical fiber link 3 in which a photon communication channel and an optical data communication channel are formed.

### First Modification Example

Regarding a first modification example, the explanation is given with the focus on the differences with the communication system 100b according to the second embodiment. In the second embodiment, the imaging device 4 is connected to the node 1b functioning as a transmitter. In contrast, in the first modification example, the explanation is given for a configuration in which the imaging device 4 is connected to the node 2b functioning as a receiver.

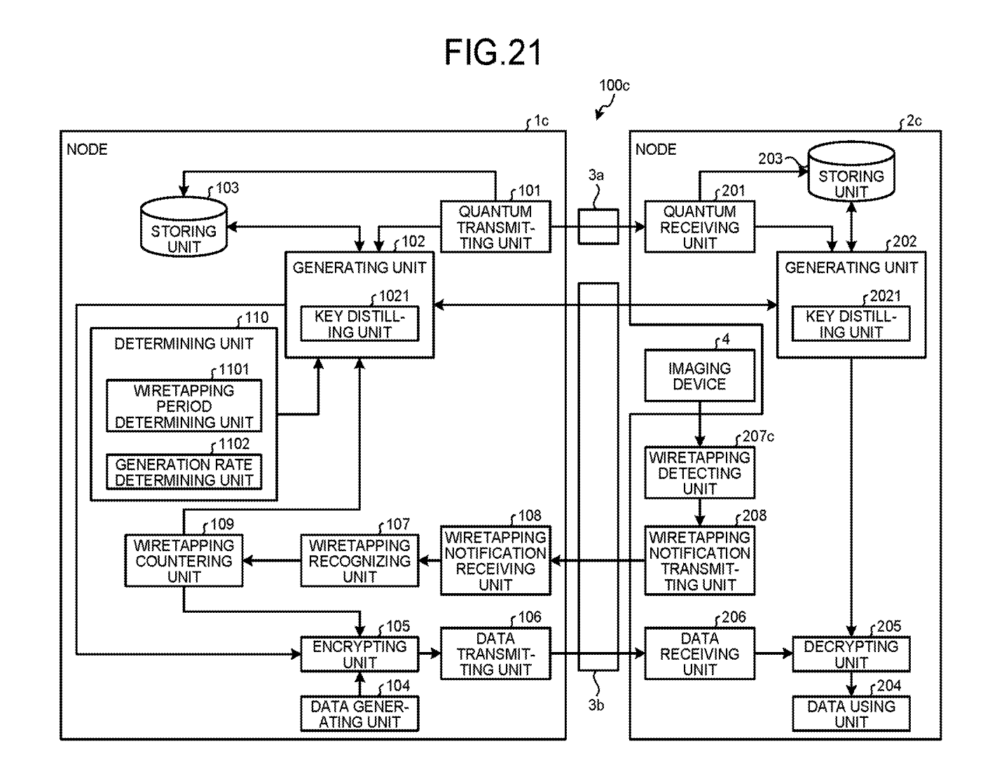

FIG. 21 is a diagram illustrating an exemplary functional block configuration of the nodes according to the first modification example of the second embodiment. Thus, explained with reference to FIG. 21 is a functional block configuration of nodes 1c and 2c in a communication system 100c.

As illustrated in FIG. 21, in the communication system 100c, the node 1c (a communication device) includes the quantum transmitting unit 101 (a sharing unit), the generating unit 102 (a first obtaining unit), the storing unit 103 (a first storing unit), the data generating unit 104, the encrypting unit 105 (an encrypting unit), the data transmitting unit 106, the wiretapping recognizing unit 107 (a recognizing unit), the wiretapping notification receiving unit 108, the wiretapping countering unit 109, and the determining unit 110 (a second determining unit). Herein, the quantum transmitting unit 101, the generating unit 102, the storing unit 103, the data generating unit 104, the encrypting unit 105, the data transmitting unit 106, the wiretapping recognizing unit 107, the wiretapping notification receiving unit 108, and the wiretapping countering unit 109 have identical functions to the quantum transmitting unit 101, the generating unit 102, the storing unit 103, the data generating unit 104, the encrypting unit 105, the data transmitting unit 106, the wiretapping recognizing unit 107, the wiretapping notification receiving unit 108, and the wiretapping countering unit 109, respectively, of the node 1 illustrated in FIG. 3 according to the first embodiment.

The determining unit 110 is a functional unit that determines the size L′ that is greater than the size L of the application data sent by the data generating unit 104 to the encrypting unit 105 during the wiretapping period T that includes the time slot within which the data that is at risk of being actually wiretapped is transmitted using the classical communication channel 3b. The method of determining the size L′ is identical to the first embodiment. The determining unit 110 includes the wiretapping period determining unit 1101 (a first determining unit) and the generation rate determining unit 1102.

The wiretapping period determining unit 1101 is a functional unit that determines the wiretapping period T that includes the time slot within which the data is at risk of actually being wiretapped in the classical communication channel 3b. The method of determining the wiretapping period T is identical to the second embodiment.

The generation rate determining unit 1102 is a functional unit that determines the generation rate R′ that is greater than the maximum value of the generation rate R at which the data generating unit 104 generates application data per unit of time and sends it to the encrypting unit 105. The method of generating the generation rate R′ is identical to the first embodiment.

As illustrated in FIG. 21, in the communication system 100c, the node 2c includes the quantum receiving unit 201, the generating unit 202 (a second obtaining unit), the storing unit 203 (a second storing unit), the data using unit 204, the decrypting unit 205 (a decrypting unit), the data receiving unit 206 (a receiving unit), a wiretapping detecting unit 207c, and the wiretapping notification transmitting unit 208. Herein, the quantum receiving unit 201, the generating unit 202, the storing unit 203, the data using unit 204, the decrypting unit 205, the data receiving unit 206, and the wiretapping notification transmitting unit 208 have identical functions to the quantum receiving unit 201, the generating unit 202, the storing unit 203, the data using unit 204, the decrypting unit 205, the data receiving unit 206, and the wiretapping notification transmitting unit 208, respectively, of the node 2 illustrated in FIG. 3 according to the first embodiment.

The wiretapping detecting unit 207c performs image analysis with respect to the image information captured by the imaging device 4 (a detecting unit), and detects a person or an object that may wiretap the data in the classical communication channel 3b within the monitoring area 5. Thus, when a person or an object that may perform wiretapping is detected as a result of performing image analysis with respect to the image information, the wiretapping detecting unit 207c detects the possibility of wiretapping. When the possibility of wiretapping is detected, the wiretapping detecting unit 207c sends a wiretapping detection signal to the wiretapping notification transmitting unit 208.

The imaging device 4 is a camera device that captures the condition of the monitoring area 5. The imaging device 4 is communicably connected to the node 2c (the wiretapping detecting unit 207c) either in a wired manner or in a wireless manner to be able to communicate data.

With such a configuration, even when the imaging device 4 is connected to the node 2, it becomes possible to achieve the same effect as the effect achieved in the second embodiment.

### Second Modification Example

Regarding a second modification example, the explanation is given with the focus on the differences with the communication system 100b according to the second embodiment. The communication system 100b according to the second embodiment includes functional units for sending and receiving photons between the nodes and for generating and sharing cryptographic keys by performing the key distillation operation. In contrast, in the second modification example, the explanation is given for a case in which a large number of common cryptographic keys are stored in advance in the storing units 103 and 203, and the operation for sending and receiving photons as well as the key distillation operation are not performed.

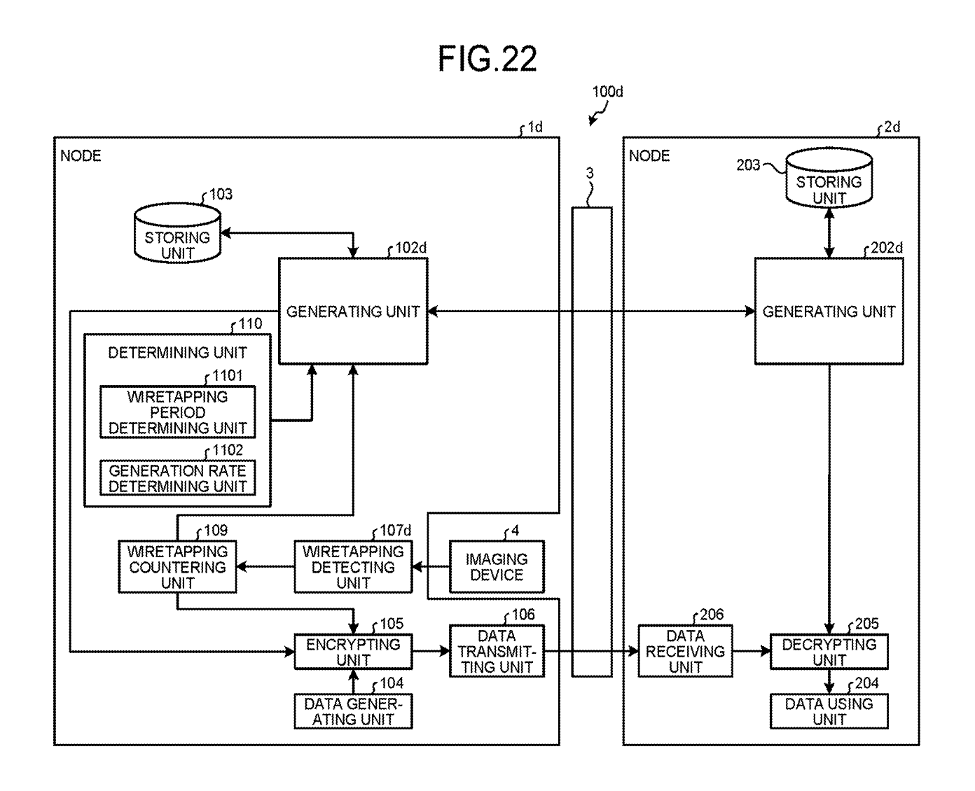

FIG. 22 is a diagram illustrating an exemplary functional block configuration of the nodes according to the second modification example of the second embodiment. Thus, explained with reference to FIG. 22 is a functional block configuration of nodes 1d and 2d.

As illustrated in FIG. 22, in a communication system 100d, the node 1d (a communication device) includes a generating unit 102d (a first obtaining unit), the storing unit 103 (a first storing unit), the data generating unit 104, the encrypting unit 105 (an encrypting unit), the data transmitting unit 106, a wiretapping detecting unit 107d (a recognizing unit), the wiretapping countering unit 109, and the determining unit 110 (a second determining unit). Herein, the storing unit 103, the data generating unit 104, the encrypting unit 105, the data transmitting unit 106, the wiretapping detecting unit 107d, the wiretapping countering unit 109, and the determining unit 110 are identical to the storing unit 103, the data generating unit 104, the encrypting unit 105, the data transmitting unit 106, the wiretapping detecting unit 107b, the wiretapping countering unit 109, and the determining unit 110, respectively, of the node 1b illustrated in FIG. 17 according to the second embodiment.

The generating unit 102d is a functional unit that generates a cryptographic key for the purpose of encrypting the data transmitted from the data transmitting unit 106, by obtaining a cryptographic key having the length (the size L′) determined by the determining unit 110. Moreover, the generating unit 102d transmits information about the size L′, which represents the length of cryptographic keys as determined by the determining unit 110, to a generating unit 202d via the optical data communication channel. Meanwhile, in the second modification example, the generating unit 102d does not include the key distilling unit 1021 for performing the key distillation operation illustrated in FIG. 17. Thus, herein, no new cryptographic key is generated. Instead, it is assumed that a large number of cryptographic keys are stored in the storing unit 103.

As illustrated in FIG. 22, in the communication system 100d, the node 2d (a communication device) includes the generating unit 202d (a second obtaining unit), the storing unit 203 (a second storing unit), the data using unit 204, the decrypting unit 205 (a decrypting unit), and the data receiving unit 206 (a receiving unit). Herein, the storing unit 203, the data using unit 204, the decrypting unit 205, and the data receiving unit 206 have identical functions to the storing unit 203, the data using unit 204, the decrypting unit 205, and the data receiving unit 206, respectively, illustrated in FIG. 17.

The generating unit 202d is a functional unit that receives information about the length (the size L′) of cryptographic keys via the optical data communication channel from the generating unit 102d and that generates a cryptographic key, which is to be used in decrypting the data received by the data receiving unit 206, by obtaining a cryptographic key having the size L′ (a first cryptographic key) from the storing unit 203. In the second modification example, the generating unit 202d does not include the key distilling unit 2021 for performing the key distilling operation illustrated in FIG. 17. Thus, herein, no new cryptographic key is generated. Instead, it is assumed that a large number of cryptographic keys are stored in the storing unit 203.

In this way, even if the operation for sending and receiving photons is not performed and new cryptographic keys are not generated by performing the key distilling operation, the cryptographic keys stored in the storing units 103 and 203 can be used to perform the encryption operation (or the decryption operation) in the same way as the communication system 100b according to the second embodiment. Moreover, as compared to a case in which the data to be transmitted is encrypted using different cryptographic keys one after another according to the conventional one-time pad method; the amount of consumption of the cryptographic keys, which are shared between and stored in the nodes 1d and 2d, can be reduced to a large extent.

Meanwhile, in the embodiments and the modification examples described above, the explanation is given for a case in which the cryptographic keys that are originally used in the one-time pad method are generated and used. However, that is not the only possible case. That is, there can be another manner of operation different from using the cryptographic keys as the one-time pad method. For example, the advanced encryption standard (AES) can be used as the encryption method. In that case, during the period of time in which there is no possibility of wiretapping, AES cryptographic keys are used in a repeated manner. However, during the period of time in which there is a possibility of wiretapping, the frequency of updating the AES cryptographic keys can be increased. That is, during the period of time in which there is no possibility of wiretapping, the cryptographic keys are used in a repeated manner. However, during the period of time in which there is a possibility of wiretapping, the intensity of encryption can be enhanced.

Meanwhile, the computer programs executed in the nodes (the communication devices) according to the embodiments and the modification examples described above can be stored in advance in, for example, the ROM 81.

Alternatively, the computer programs executed in the nodes according to the embodiments and the modification examples described above can be recorded as installable or executable files in a computer-readable recording medium such as a compact disk read only memory (CD-ROM), a flexible disk (FD), a compact disk recordable (CD-R), or a digital versatile disk (DVD); and can be provided as a computer program product.

Still alternatively, the computer programs executed in the nodes according to the embodiments and the modification examples described above can be saved as downloadable files on a computer connected to the Internet or can be made available for distribution through a network such as the Internet.

Meanwhile, the computer programs executed in the nodes according to the embodiments and the modification examples described above can make a computer function as the functional units of a node. In such a computer, the CPU 80 can read the computer programs from a computer-readable memory medium, load them in a main memory device, and execute them.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1: A communication device comprising:
a first determining unit configured to determine a period of time during which there is a possibility of wiretapping of data present in a data communication channel which establishes connection to another communication device;
a second determining unit configured to determine, with a length of the period of time as unit of time, size of a cryptographic key which is used for encrypting data to be transmitted to the other communication device via the data communication channel during each unit of time;
a first obtaining unit configured to obtain a first cryptographic key, which has the size, from a first storing unit which stores therein cryptographic keys that have been shared with the other communication device;
a recognizing unit configured to recognize a possibility of wiretapping with respect to the data communication channel; and
an encrypting unit configured to, until the possibility of the wiretapping is recognized by the recognizing unit, repeatedly encrypts data, which is to be transmitted to the other communication device, during each unit of time using the first cryptographic key obtained by the first obtaining unit.

2: The device according to claim 1, further comprising a sharing unit configured to share a photon string with the other communication device and obtain a bit string corresponding to the photon string from the other communication device using quantum key distribution performed with the other communication device via a quantum communication channel, wherein
the data communication channel and the quantum communication channel are formed in same physical medium, and
the recognizing unit recognizes the possibility of the wiretapping based on error rate of the photon string in the quantum communication channel.

3: The device according to claim 1, wherein the recognizing unit recognizes the possibility of the wiretapping based on a detection result of a detecting unit that detects information in neighborhood of the data communication channel.

4: The device according to claim 2, wherein the first determining unit determines the period of time based on a first time period and a second time period, the first time period representing unit of time in which the error rate is measured, and the second time period representing, when the other communication device detects the possibility of the wiretapping, a period of time starting from detection of the possibility of the wiretapping by the other communication device until the recognizing unit recognizes the possibility of the wiretapping as a result of a notification of detection of the possibility of the wiretapping by the other communication device.

5: The device according to claim 1, wherein, when the recognizing unit recognizes the possibility of the wiretapping, the encrypting unit encrypts each piece of data, which is to be transmitted to the other communication device, using a different cryptographic key, which is different from the first cryptographic key obtained by the first obtaining unit, according to one-time pad method.

6: The device according to claim 1, wherein
when the recognizing unit recognizes the possibility of the wiretapping, the encrypting unit stops operation of repeatedly encrypting data, which is to be transmitted to the other communication device, using the first cryptographic key, and
when the recognizing unit recognizes that the possibility of the wiretapping no longer exists, the encrypting unit repeatedly encrypts data, which is to be transmitted to the other communication device, using a second cryptographic key that is obtained by the first obtaining unit and that is different from the first cryptographic key.

7: The device according to claim 1, wherein
the second determining unit determines the size that is greater than size of data to be transmitted to the other communication device, and
the encrypting unit encrypts data, which is to be transmitted to the other communication device, according to one-time pad method using the first cryptographic key.

8: The device according to claim 1, wherein the second determining unit calculates and determines the size based on generation rate of data that is to be transmitted to the other communication device and based on the period of time.

9: The device according to claim 1, further comprising:
a sharing unit configured to share a photon string with the other communication device using quantum key distribution performed with the other communication channel via a quantum communication channel; and
a key distilling unit configured to perform a key distillation operation to generate the cryptographic key from the bit string, wherein
the data communication channel and the quantum communication channel are formed in same physical medium.

10: A communication device comprising:
a receiving unit configured to receive, from the communication device according to claim 1, data which has been encrypted by the encrypting unit;
a second obtaining unit configured to obtain a first cryptographic key having the size from a second storing unit which stores therein cryptographic keys that have been shared with the communication device using quantum key distribution; and
a decrypting unit configured to, until the possibility of the wiretapping is recognized by the recognizing unit, repeatedly decrypts the encrypted data during each unit of time using the first cryptographic key obtained by the second obtaining unit.

11: A communication system comprising:
the communication device according to claim 1.

12: A communication method comprising:
determining a period of time during which there is a possibility of wiretapping of data present in a data communication channel which establishes connection to another communication device;
determining, with a length of the period of time as unit of time, size of a cryptographic key which is used for encrypting data to be transmitted to the other communication device via the data communication channel during each unit of time;
obtaining a cryptographic key, which has the size, from a storing unit which stores therein cryptographic keys that have been shared with the other communication device;
recognizing a possibility of wiretapping with respect to the data communication channel; and
encrypting that, until the possibility of the wiretapping is recognized, includes repeatedly encrypting data, which is to be transmitted to the other communication device, during each unit of time using the obtained cryptographic key having the size.

13: A computer program product comprising a computer readable medium including programmed instructions, wherein the programmed instructions, when executed by a computer, cause the computer to perform:
determining a period of time during which there is a possibility of wiretapping of data present in a data communication channel which establishes connection to another communication device;
determining, with a length of the period of time as unit of time, size of a cryptographic key which is used for encrypting data to be transmitted to the other communication device via the data communication channel during each unit of time;
obtaining a cryptographic key, which has the size, from a storing unit which stores therein cryptographic keys that have been shared with the other communication device;
recognizing a possibility of wiretapping with respect to the data communication channel; and
encrypting that, until the possibility of the wiretapping is recognized, includes repeatedly encrypting data, which is to be transmitted to the other communication device, during each unit of time using the obtained cryptographic key having the size.

14: A communication system comprising:
the communication device according to claim 10.
